(19) United States
(12) Patent Application Publication
(10) Pub. No.: US 2018/0127148 A1
(43) Pub. Date: May 10, 2018

(54) TRANSPORT PACKAGE

(71) Applicant: KapStone Container Corporation, Northbrook, IL (US)

(72) Inventors: Wayne KUHN, Palos Park, IL (US); Kevin MOORE, Glen Ellyn, IL (US); Andrew LAACKMAN, Wilmette, IL (US)

(21) Appl. No.: 15/806,733

(22) Filed: Nov. 8, 2017

Related U.S. Application Data
(60) Provisional application No. 62/419,846, filed on Nov. 9, 2016.

(51) Int. Cl. B65D 19/42; B65D 19/20; B62B 3/00

(52) U.S. Cl. CPC B65D 19/42; B62B 2501/062; B62B 3/002; B65D 2519/00019; B65D 2519/00024; B65D 2519/00029; B65D 2519/00034; B65D 2519/00054; B65D 2519/00159; B65D 2519/00497; B65D 2519/00781; B65D 2519/00174; B65D 2519/00069; B62B 2202/90; B65D 19/20

(57) ABSTRACT

A transport package includes a support base and a cover member coupled to the base. The support base supports a product display vehicle and the cover member surrounds the display vehicle to block product stored in the display vehicle from exiting the display vehicle during shipping.

### PRIORITY CLAIM

This application claims priority under 35 U.S.C. § 119(e) to U.S. Provisional Application Ser. No. 62/419,846, filed Nov. 9, 2016, which is expressly incorporated by reference herein.

### BACKGROUND

The present disclosure relates to packaging, and particularly to packaging for the transportation of products. More particularly, the present disclosure relates to packaging for the transportation of products arranged in a display vehicle used in retail locations.

### SUMMARY

A transport package in accordance with the present disclosure includes a support base and a cover member coupled to the base. The support base supports a product display vehicle and the cover member surrounds the display vehicle to block products stored in the display vehicle from exiting the display vehicle during shipping.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a upper perspective view of a work-in-progress (WIP) cart having a platform and rollers coupled to the platform to support the platform for rolling movement and suggesting that the WIP cart is used during assembly of a transport package as suggested in FIGS. 1-9;

FIG. 2 is a view similar to FIG. 1 showing a suspension base in accordance with the present disclosure coupled to the WIP cart and that the suspension base includes a perimeter wall and corner blocks coupled to the perimeter wall and suggesting that an optional access aperture (shown in phantom) may be formed in the perimeter wall to allow access to a product display vehicle to place products thereon;

FIG. 3 is a view similar to FIG. 2 showing a mobile display base in accordance with the present disclosure positioned for insertion into the suspension base and that the display base includes a tray and rollers coupled to the tray to support the tray for rolling movement;

FIG. 4 is a view similar to FIG. 3 showing that the perimeter wall of the suspension base is sized to receive the display base therein and suggesting that the corner blocks are positioned to receive the display base to support the display base on the suspension base as suggested in FIG. 5;

FIG. 5 is a view similar to FIG. 4 showing the display base located in the suspension base to form a support base;

FIG. 6 is a side elevational view of the support base of FIG. 5 showing the rollers of the display base suspended above the WIP cart when the tray of the display base is positioned on the corner blocks of the suspension base;

FIG. 7 is a view similar to FIG. 5 showing a cover member positioned for insertion into the suspension base over the display base as suggested in FIG. 8;

FIG. 8 is a view similar to FIG. 7 showing the cover member coupled to the support base to form a transport package and that a strap is positioned in notches formed in both the suspension base and the cover member to hold the cover member on the support base;

FIG. 9 is a diagrammatic view of a transport package assembly line showing that the suspension base and display base are assembled and positioned on the WIP cart, the display vehicle is assembled and loaded with product, the loaded display vehicle is positioned on the display base, the cover member is coupled to the display vehicle, and the assembled transport package is wrapped in a stretch wrapper, and suggesting that the transport package is removed from the WIP cart for reuse in the assembly line;

FIG. 10 is a partial perspective view of the support base showing that the suspension base supports the display base and suggesting that an operator at a retail location begins disassembly of the display base from the suspension base by positioning a fork of a pallet jack under the support base;

FIG. 11 is a view similar to FIG. 10 showing the fork of the pallet jack positioned under the support base and suggesting that the fork is lifted to support the support base on the fork;

FIG. 12 is a view similar to FIG. 11 showing the fork of the pallet jack lifted to support the support base and suggesting that the operator unwraps the suspension base while the display base is supported on the fork;

FIG. 13 is a top plan view of one embodiment of a blank used to form a suspension base;

FIG. 14 is a lower perspective view of the suspension base formed by the blank in FIG. 13;

FIG. 15 is a top plan view of the suspension base of FIG. 14;

FIG. 16 is a top plan view of one embodiment of a blank used to form the tray of the display base;

FIG. 17 is a top plan view of another embodiment of a blank used to form a suspension base;

FIG. 18 is a top plan view of another embodiment of a blank used to form the tray of the display base;

FIG. 19 is a top plan view of another embodiment of a blank used to form the tray of the display base;

FIG. 20 is a top plan view of another embodiment of a blank used to form the tray of the display base;

FIG. 21 is a top plan view of a blank used to form a bottom pad of the tray of FIG. 20;

FIG. 22 is a lower perspective view of the tray formed by the blanks of FIGS. 20 and 21 showing that rollers are attached to lock tabs of the blanks to support the tray for rolling movement;

FIG. 23 is a view similar to FIG. 22;

FIG. 24 is a lower perspective view of another embodiment of a tray having feet for supporting the tray;

FIG. 25 is a top plan view of another embodiment of a blank used to form a suspension base;

FIG. 26 is a top plan view of an assembled suspension base formed by the blank of FIG. 25 showing swing arms extending toward one another to provide a floor used to support the display base;

FIG. 27 is a top plan view of another embodiment of a blank used to form a suspension base;

FIG. 28 is a lower perspective view of the suspension base formed by the blank in FIG. 27;

FIG. 29 is a top plan view of the suspension base of FIG. 28;

FIG. 30 is a top plan view of another embodiment of a blank used to form a suspension base;

FIG. 31 is a lower perspective view of the suspension base formed by the blank in FIG. 30;

FIG. 32 is a top plan view of the suspension base of FIG. 31;

FIG. 33 is a top plan view of another embodiment of a blank used to form a suspension base;

FIG. 34 is a lower perspective view of the suspension base formed by the blank in FIG. 33;

FIG. 35 is a top plan view of the suspension base of FIG. 34;

FIG. 36 is a top plan view of another embodiment of a blank used to form a suspension base;

FIG. 37 is a lower perspective view of the suspension base formed by the blank in FIG. 36;

FIG. 38 is a top plan view of the suspension base of FIG. 37;

FIG. 39 is a top plan view of another embodiment of a blank used to form a suspension base;

FIG. 40 is a lower perspective view of the suspension base formed by the blank in FIG. 39;

FIG. 41 is a top plan view of the suspension base of FIG. 40;

FIG. 42 is a top plan view of another embodiment of a blank used to form part of a suspension base;

FIG. 43 is a lower perspective view of the suspension base formed by the blank in FIG. 42;

FIG. 44 is a top plan view of the suspension base of FIG. 43;

FIG. 45 is a top plan view of another embodiment of a blank used to form a suspension base;

FIG. 46 is a lower perspective view of the suspension base formed by the blank in FIG. 45;

FIG. 47 is a top plan view of the suspension base of FIG. 46;

FIG. 48 is a top plan view of one embodiment of a blank used to form a suspension cover;

FIG. 49 is a side perspective view of the suspension cover formed by the blank in FIG. 48 showing that the suspension cover includes a suspension base portion and cover member portion;

FIG. 50 is a lower perspective view of the combination suspension base and cover member of FIG. 49;

FIG. 51 is a top plan view of another embodiment of a blank used to form part of a suspension cover;

FIG. 52 is a side perspective view of the suspension cover formed by the blank in FIG. 51 showing that the suspension cover includes a suspension base portion and cover member portion;

FIG. 53 is a lower perspective view of the combination suspension base and cover member of FIG. 52;

FIG. 54 is a top plan view of another embodiment of a blank used to form a suspension corners that can be arranged to define a suspension base;

FIG. 55 is an upper perspective view of the suspension corner formed by the blank in FIG. 54;

FIG. 56 is a lower perspective view of another embodiment of a suspension base;

FIG. 57 is an upper perspective view of another embodiment of a tray for a display base;

FIG. 58 is a top plan view of another embodiment of a blank used to form the tray of FIG. 57; and

FIG. 59 is a top plan view of a blank used to form a bottom pad of the tray of FIG. 57.

### DETAILED DESCRIPTION

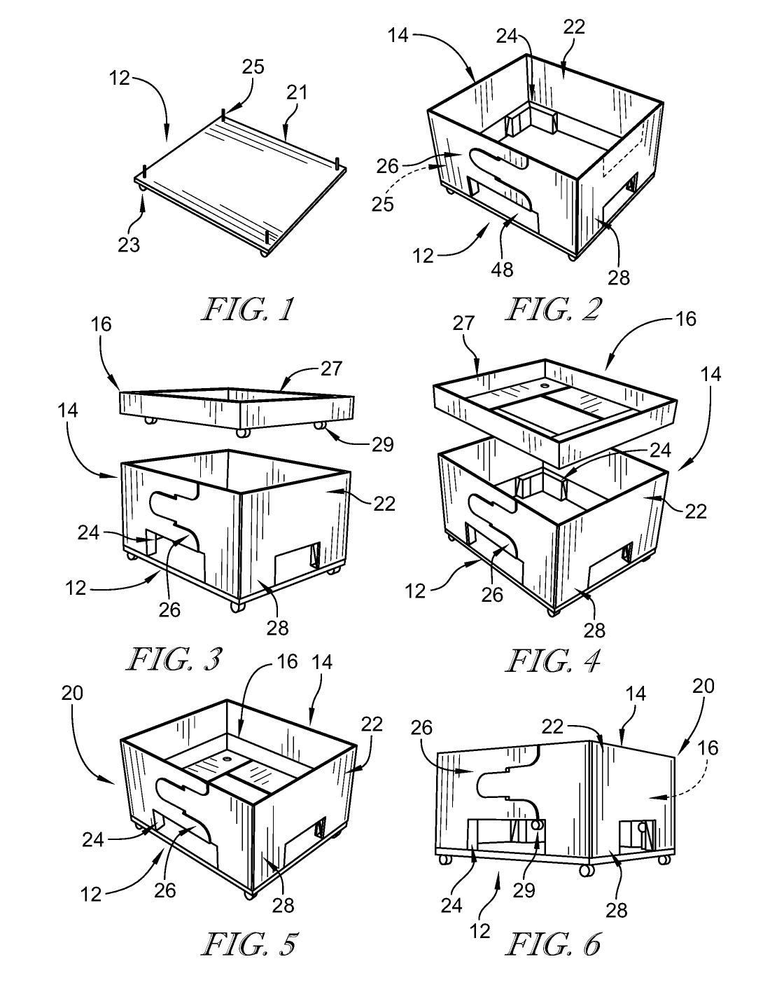

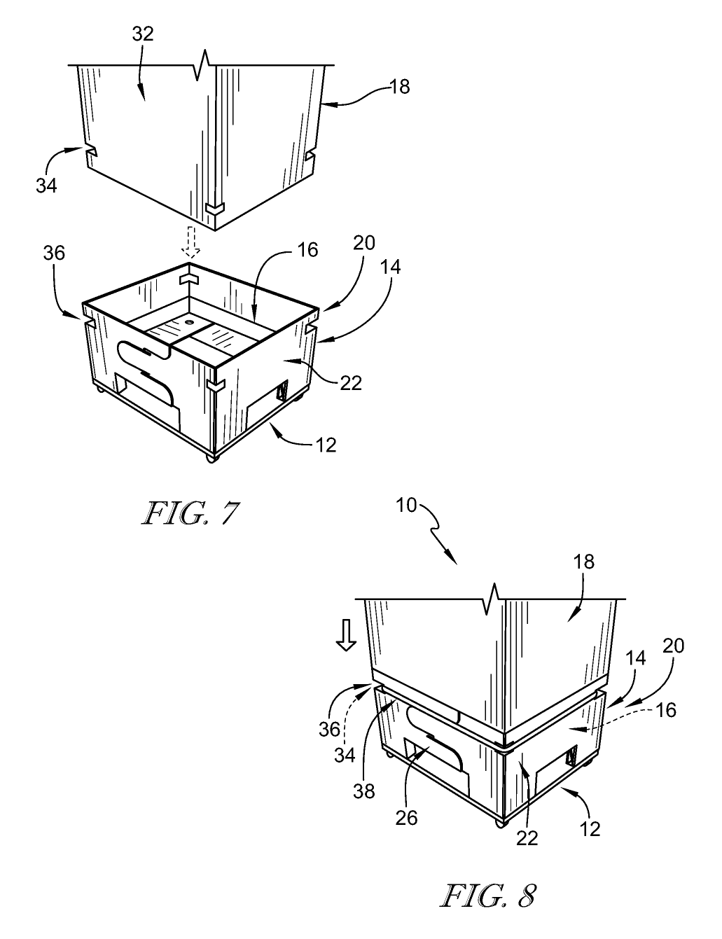

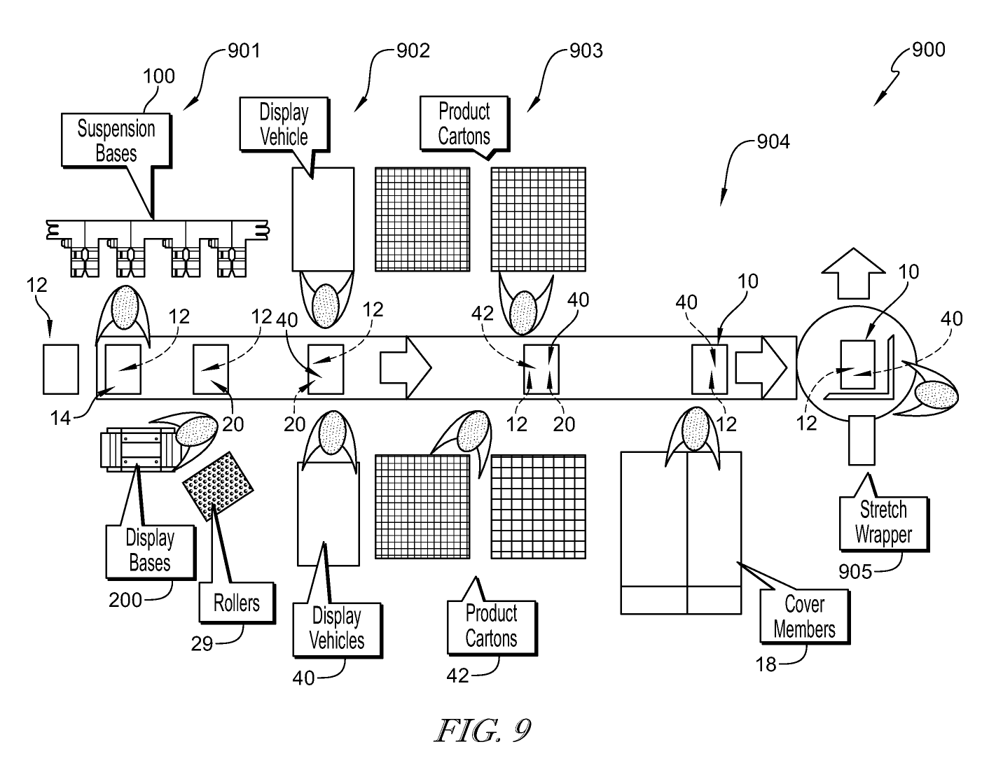

A transport package 10 in accordance with the present disclosure includes a support base 20 and a cover member 18 (sometimes called a dust cover or half-slotted container) coupled to support base 20 as suggested in FIG. 8. Support base 20 includes a suspension base 14 and a mobile display base 16 received in suspension base 14 as suggested in FIG. 7. Support base 20 is assembled onto a work-in-progress (WIP) cart 12 as suggested in FIGS. 1-6. A product display vehicle 40, storing cartons of product 42 therein, is mounted on support base 20 and enclosed by cover member 18 on an assembly line 900 to form transport package 10 around display vehicle 40 for transport of display vehicle 40 to a retail location where product 42 is sold to consumers as suggested in FIG. 9.

WIP cart 12 includes a platform 21 and rollers 23 coupled to platform 21 as shown in FIG. 1. Rollers 23 support platform 21 for rolling movement. Optional pins 25 are coupled to platform 21 for locating suspension base 14 relative to WIP cart 12 as suggested in FIGS. 1 and 2. Platform 21 may be formed from wood, plastic, metal, corrugated material, or composite material, combinations thereof, or any other suitable material. In some embodiments, rollers 23 are caster wheels.

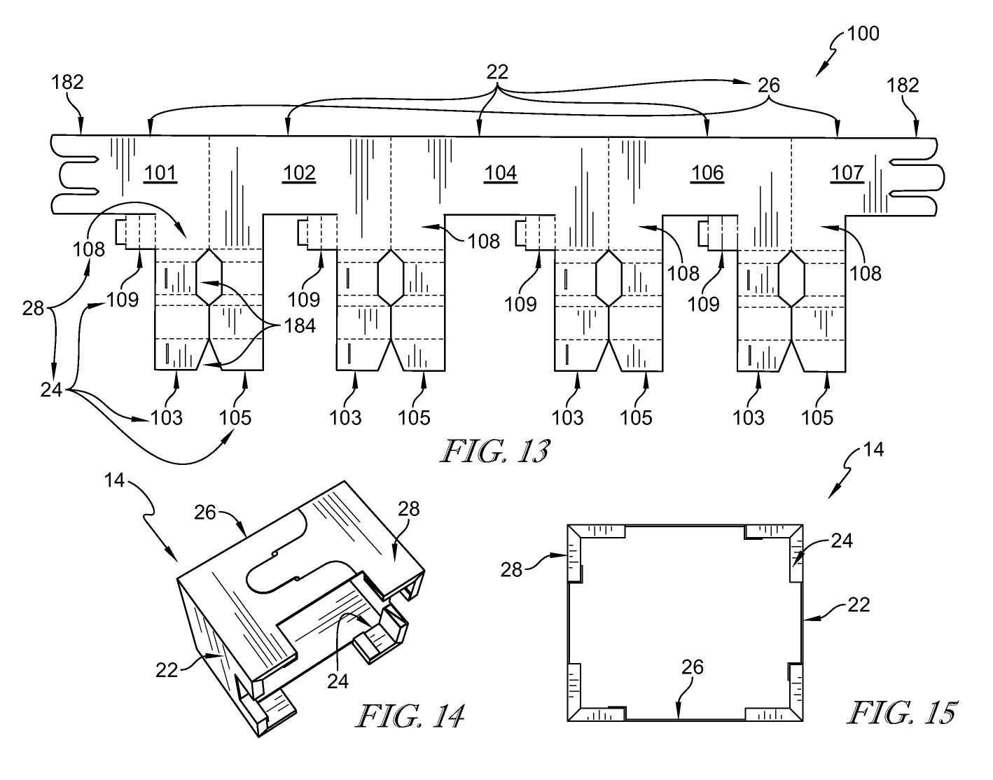

Suspension base 14 includes a perimeter wall 22 and corner blocks 24 coupled to perimeter wall 22 as shown in FIG. 2. Suspension base 14 is formed from a blank 100 of material, as shown in FIG. 13, which is cut and folded into shape. As shown and described herein, when making reference to a blank of material, solid lines denote a cut line where adjacent portions of material are severed from one another and dashed lines denote a fold line where portions of material are folded relative to one another. In some examples, fold lines are scored or perforated.

An interlock 26 of perimeter wall 22 is configured to hold the ends of blank 100 together. Suspension base 14 is formed to include feet 28 such that one or more windows 48 are defined between adjacent feet 28. In some embodiments, one or more cutouts are formed around an upper edge of perimeter wall 22, as suggested by the phantom line in FIG. 2, such as to form a window to allow loading of product on lower shelves of a display vehicle on WIP cart 12. In some embodiments, corner blocks 24 are formed from wood blocks, honeycomb structures, laminated corrugate material, or other material secured to perimeter wall 22.

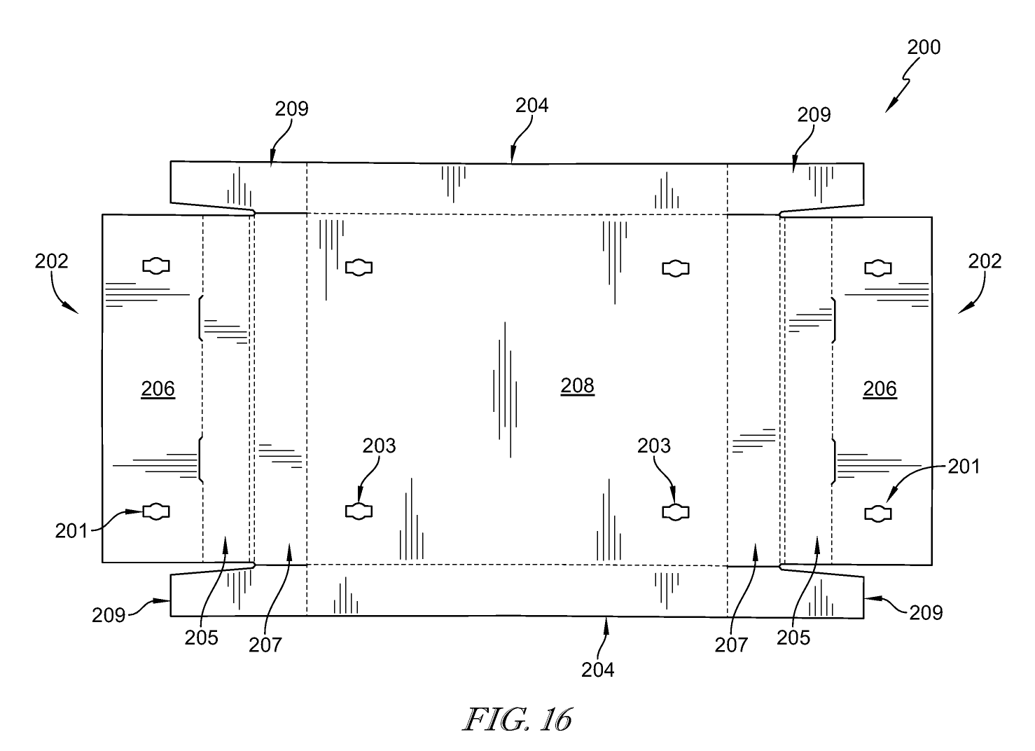

Display base 16 includes a tray 27 and rollers 29 coupled to tray 27 as shown in FIG. 3. In the illustrative embodiment, display base 16 is formed from a blank 200 of material, as shown in FIG. 16, which is cut and folded into shape. Rollers 29 support tray 27 for rolling movement. Suspension base 14 is configured to receive display base 16 inside perimeter wall 22 and to support display base 16 on corner blocks 24 such that rollers 29 are suspended relative to a bottom portion of feet 28 as suggested in FIGS. 3-6. Suspension base 14 and display base 16 combine to form a support base 20.

Suspension base 14 is configured to receive cover member 18, as suggested in FIG. 7, for positioning over display vehicle 40 (not shown in FIG. 7) to form transport package 10 used to transport display vehicle 40 to a retail location. Display vehicle 40 can include cabinets, risers, stacked trays, three-sided structures, and other structures that support or otherwise store product for display and transportation. The display vehicles can be of various sizes. In the illustrative embodiment, cover member 18 aligns with display base 16 such that cover member 18 is supported by display base 16. Cover member 18 includes a plurality of adjacent panels 32 configured to surround display vehicle 40 to block product 42 stored in display vehicle 40 from exiting display vehicle 40.

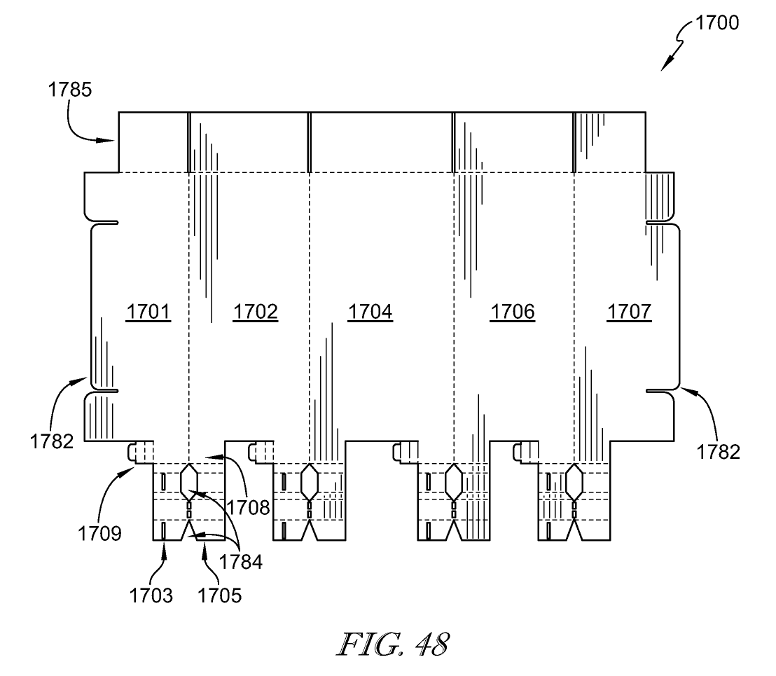

In one example, cover member 18 is formed to include notches 34 and suspension base 14 is formed to include notches 36. Notches 34, 36 align when cover member 18 is received in suspension base 14, and a strap 38 is positioned around perimeter wall 22 and in notches 34, 36 to hold cover member 18 on support base 20. In some embodiments, strap 38 is used without notches 34, 36. In some embodiments, cover member 18 is sized to receive suspension base 14 such that cover member 18 extends around perimeter wall 22. In some embodiments, a suspension base and a cover member are formed together as a unitary suspension cover, such as suggested in FIGS. 48-53.

An illustrative assembly line 900 for forming transport package 10 is shown in FIG. 9. WIP carts 12 move along assembly line 900 to carry components of transport package 10 as transport package 10 is being assembled. At a first station 901 of assembly line 900, blank 100 is folded to assemble suspension base 14 which is then mounted on WIP cart 12. Blank 200 is folded to assemble tray 27 and rollers 29, which are casters in the illustrative embodiment, are coupled to tray 27 to form display base 16. Display base 16 is received in suspension base 14 to form support base 20 which then moves on to a second station 902 on WIP cart 12.

At station 902, display vehicle 40 is assembled and mounted on support base 20 as suggested in FIG. 9. At a third station 903, one or more cartons of product 42 are loaded into display vehicle 40. At a fourth station 904, cover member 18 (sometimes called a dust cover) is mounted on support base 20 over display vehicle 40 to form transport package 10. In the illustrative embodiment, transport package 10 is positioned in a stretch wrapper 905 to place a stretch-wrap film around transport package 10. In some embodiments, the stretch wrapper is not used. Once transport package 10 is assembled, WIP cart 12 can be removed and returned to station 901 for reuse in assembly line 900.

Transport packages 10, including display vehicles 40 therein, are shipped to retail locations to sell products 42 to consumers. In some embodiments, four transport packages 10 are positioned in a rectangular pattern and in confronting relation to be strapped together for shipment as a unit on a pallet. Suspension base 14 and cover member 18 allow handling of transport package 10 while protecting display base 16 and display vehicle 40 from damage.

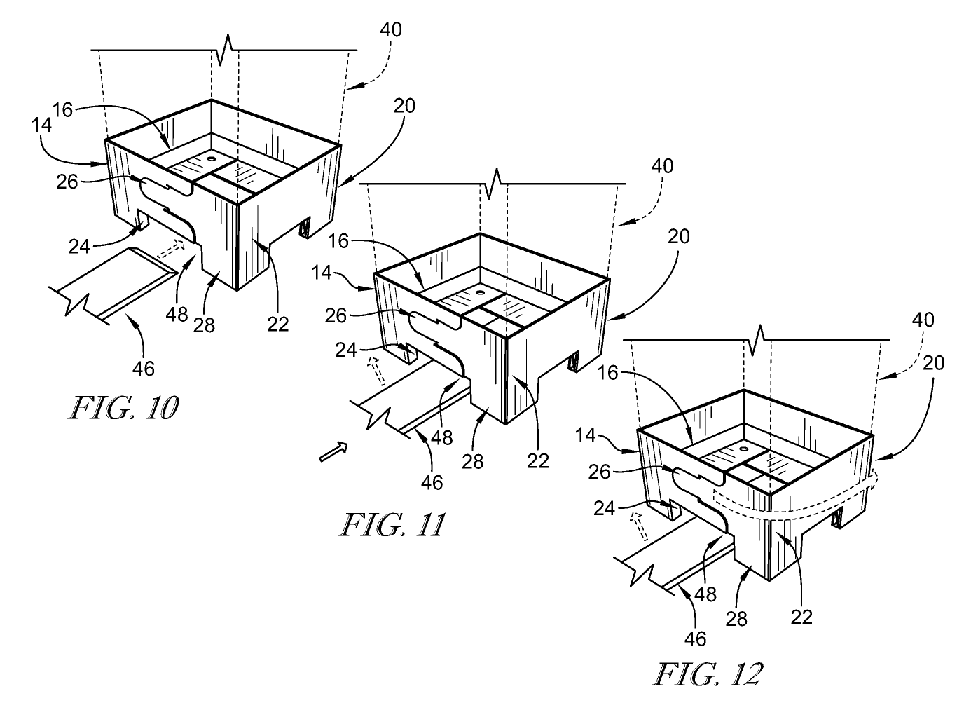

Once received at a retail location, operators disassemble transport package 10 from around display vehicle 40 for use in the retail location as suggested in FIGS. 10-12. Cover member 18 is removed from support base 20 and a fork 46 of a pallet jack, for example, is positioned through window 48 between feet 28 of suspension base 14 as suggested in FIGS. 10 and 11. Fork 46 is lifted to support suspension base 14 and display base 16 on fork 46 as suggested in FIGS. 11 and 12. The weight of display vehicle 40 (shown in phantom) and display base 16 is substantially removed from corner blocks 24 when supported by fork 46 as fork 46 engages with display base 16 before suspension base 14. For example, display base 16 can be arranged to extend into windows 48 or the weight of display vehicle 40 can cause deformation of corner blocks 24 when not supported at a lower end of feet 28. In some embodiments, a gap is formed between a top portion of corner blocks 24 and a top portion of windows 48 to allow display base 16 to be lifted off of corner blocks 24 as support base 20 is lifted.

An operator peels away suspension base 14 from display base 16 by pulling apart interlock 26 as suggested in FIG. 12. Display base 16 and display vehicle 40 remain supported on fork 46 which is then lower to place display base 16 on a ground level. In the illustrative embodiment, display vehicle 40 remains attached to display base 16 to form a mobile display for convenient positioning around the retail location on rollers 29 of display base 16.

One embodiment of a blank 100 used to form suspension base 14 is shown in FIG. 13. Blank 100 includes side panels 102, 106, a back panel 104, and end panels 101, 107. Grips 182 of end panels 101, 107 engage one another to form interlock 26. Panels 101, 102, 104, 106, 107 form perimeter wall 22 of suspension base 14.

In the illustrative embodiment, corner blocks 24 are formed from roll panels 103, 105 and lock panels 109 as suggested in FIG. 13. Roll panels 103, 105 each include a plurality of sections which fold onto one another to align with lower sections 108 of the upper panels 101, 102, 104, 106, 107 to form feet 28 of suspension base 14. The sections of roll panels 103, 105 are sized such that roll panels meet with one another at respective corners of perimeter wall 22 when suspension base 14 is formed. For example, in the illustrative embodiment, gaps 184 are formed between roll panels 103, 105 to allow panels 101, 102, 104, 106, 107 to fold relative to one another without interference between roll panels 103, 105. Other fold patterns for corner blocks 24 are possible, such as triangular or other polygonal shape. Lock panel 109 engages with roll panel 103 to hold roll panel 103 in a folded state. In some embodiments, another lock panel is included in blank 100 to hold roll panel 105 in a folded state. In some embodiments, no lock panels 109 are used. In some embodiments, tape or adhesive is used to hold roll panels 103, 105 in a folded state. The erected suspension base 14 is shown in FIGS. 14 and 15.

One embodiment of a blank 200 used to form tray 27 of display base 16 is shown in FIG. 16. Blank 200 includes end flaps 202 and side flaps 204 coupled to a bottom panel 208. End flaps 202 each include a floor panel 206 and wall panels 205, 207. Wall panel 207 is folded relative to bottom panel 208, and wall panel 205 is folded relative to wall panel 207 into confronting relation with wall panel 207. Floor panel 206 is folded relative to wall panel 205 to align keyholes 201, 203 of floor panel 206 and bottom panel 208, respectively. In some embodiments, rollers 29 engage with keyholes 201, 203 to lock rollers 29 onto tray 27.

Retention tabs 209 extend from side flaps 204 as shown in FIG. 16. Retention tabs 209 are folded relative to side flaps 204, and side flaps 204 are folded relative to bottom panel 208 such that retention tabs 209 extend along bottom panel 208. Retention tabs 209 are received between wall panels 205, 207 to hold side flap 204 in a folded state. In some embodiments, tape or adhesive is used to hold tray 27 in a folded state.

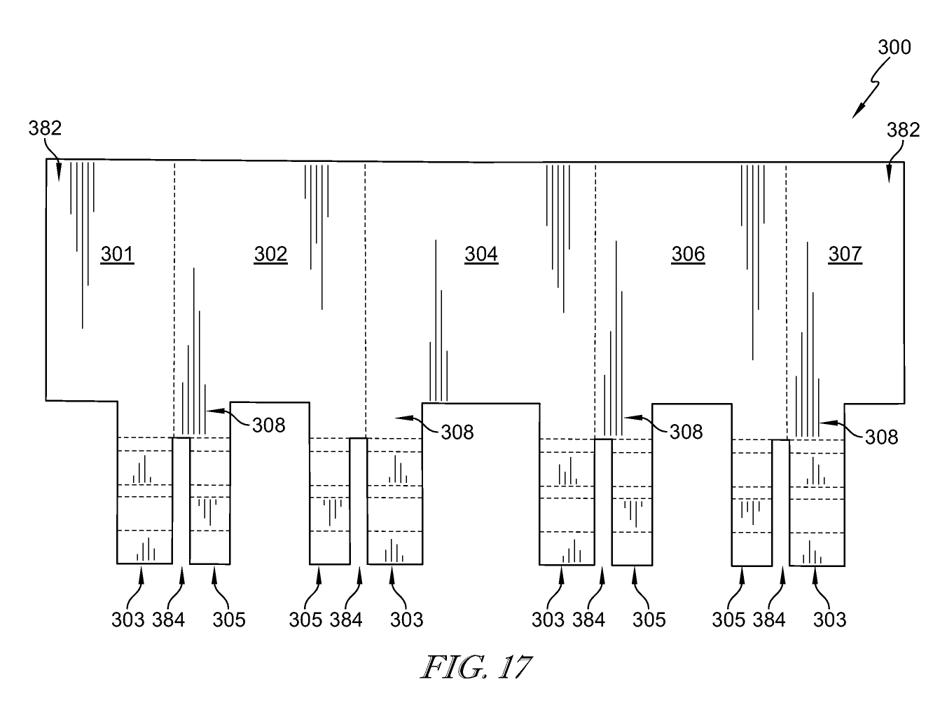

Another embodiment of a blank 300 used to form a suspension base in accordance with the present disclosure is shown in FIG. 17. Blank 300 is similar to blank 100 of FIG. 13, and includes side panels 302, 306, a back panel 304, and end panels 301, 307. In some embodiments, sections 382 of end panels 301, 307 align with one another as panels 301, 302, 304, 306, 307 fold relative to one another to form a perimeter wall of a suspension base. In some embodiments, sections 382 of end panels 301, 307 overlap one another as panels 301, 302, 304, 306, 307 fold relative to one another to form a perimeter wall of a suspension base. In some embodiments, sections 382 of end panels 301, 307 are bonded to one another with tape or an adhesive as panels 301, 302, 304, 306, 307 fold relative to one another to form a perimeter wall of a suspension base.

In the illustrative embodiment, corner blocks of a suspension base are formed from roll panels 303, 305 as suggested in FIG. 17. Roll panels 303, 305 each include a plurality of sections which fold onto one another to align with lower sections 308 of the upper panels 301, 302, 304, 306, 307 to form feet of a suspension base. Gaps 384 are formed between roll panels 303, 305 to allow panels 301, 302, 304, 306, 307 to fold relative to one another without interference between roll panels 303, 305. In some embodiments, tape or adhesive is used to hold roll panels 303, 305 in a folded state.

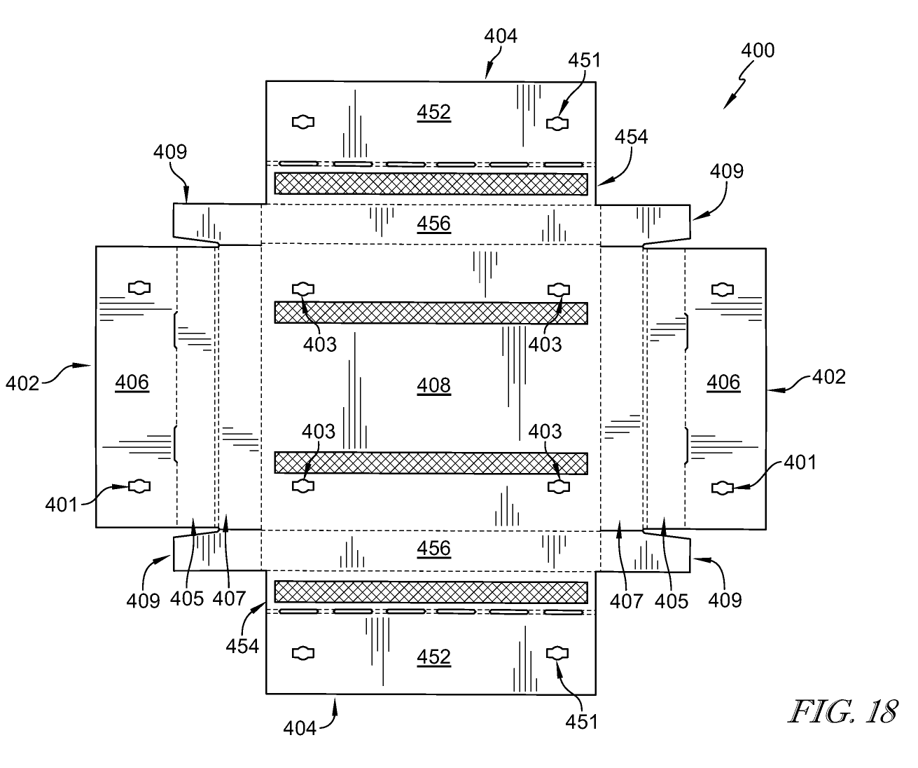

Another embodiment of a blank 400 used to form a tray of a display base in accordance with the present disclosure is shown in FIG. 18. Blank 400 is similar to blank 200, and includes end flaps 402 and side flaps 404 coupled to a bottom panel 408. End flaps 402 each include a floor panel 406 and wall panels 405, 407. Wall panel 407 is folded relative to bottom panel 408, and wall panel 405 is folded relative to wall panel 407 into confronting relation with wall panel 407. Floor panel 406 is folded relative to wall panel 405 to align keyholes 401, 403 of floor panel 406 and bottom panel 408, respectively. In some embodiments, rollers engage with keyholes 401, 403 to lock the rollers onto the tray.

End flaps 404 each include a floor panel 452 and wall panels 454, 456. Wall panel 456 is folded relative to bottom panel 408, and wall panel 454 is folded relative to wall panel 456 into confronting relation with wall panel 456. Floor panel 452 is folded relative to wall panel 454 to align keyholes 451, 403 of floor panel 452 and bottom panel 408, respectively. In some embodiments, rollers engage with keyholes 451, 403 to lock the rollers onto the tray. Retention tabs 409 extend from wall panels 456. Retention tabs 409 are folded relative to wall panels 456 such that retention tabs 409 extend along bottom panel 408. Retention tabs 409 are received between wall panels 405, 407 of end flaps 402 to hold side flap 404 in a folded state. In some embodiments, tape or adhesive is used to hold the tray formed by blank 400 in a folded state.

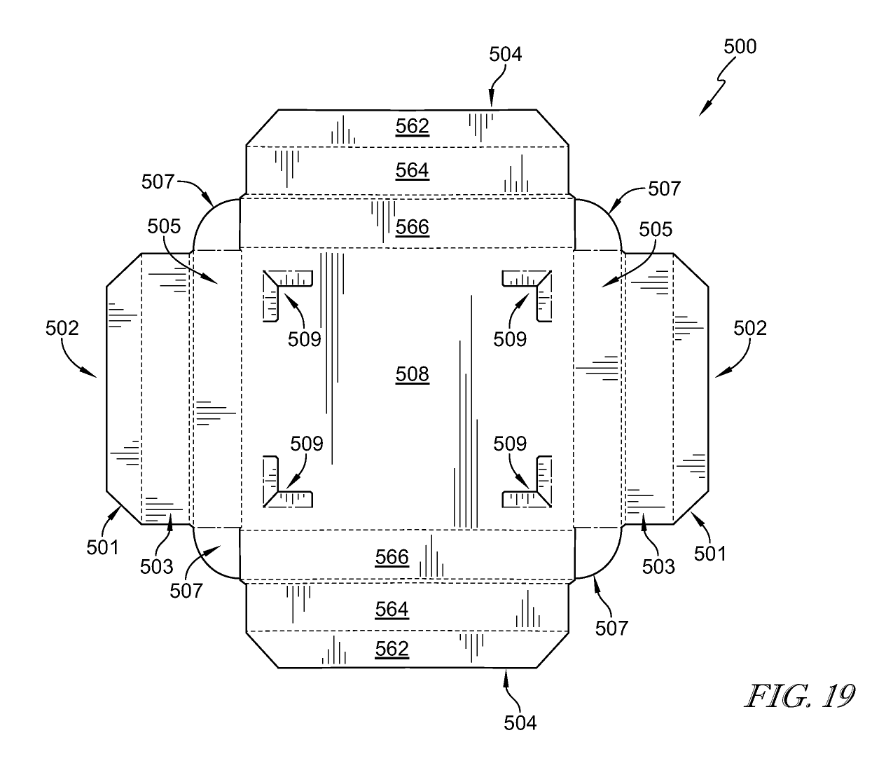

Another embodiment of a blank 500 used to form a tray of a display base in accordance with the present disclosure is shown in FIG. 19. Blank 500 includes end flaps 502 and side flaps 504 coupled to a bottom panel 508. Bottom panel 508 is formed to include lock tabs 509 configured to engage with rollers to hold the rollers on the tray formed by blank 500. End flaps 502 each include a spacer tab 501 and wall panels 503, 505. Spacer tab 501 is folded relative to wall panel 503 into confronting relation with wall panel 503. Wall panel 503 folded relative to wall panel 505 into confronting relation with wall panel 505 such that spacer tab 501 is positioned between wall panels 503, 507. Wall panel 505 is folded relative to bottom panel 508.

End flaps 504 each include a spacer tab 562 and wall panels 564, 566 as shown in FIG. 19. Spacer tab 562 is folded relative to wall panel 564 into confronting relation with wall panel 564. Wall panel 564 folded relative to wall panel 566 into confronting relation with wall panel 566 such that spacer tab 562 is positioned between wall panels 564, 566. Wall panel 566 is folded relative to bottom panel 508.

Retention tabs 507 extend from wall panels 505 as shown in FIG. 19. Retention tabs 507 are folded relative to wall panels 505 such that retention tabs 507 extend along bottom panel 508. Retention tabs 507 are received between wall panels 564, 566 of end flaps 504 to hold side flap 502 in a folded state. In some embodiments, tape or adhesive is used to hold the tray formed by blank 500 in a folded state.

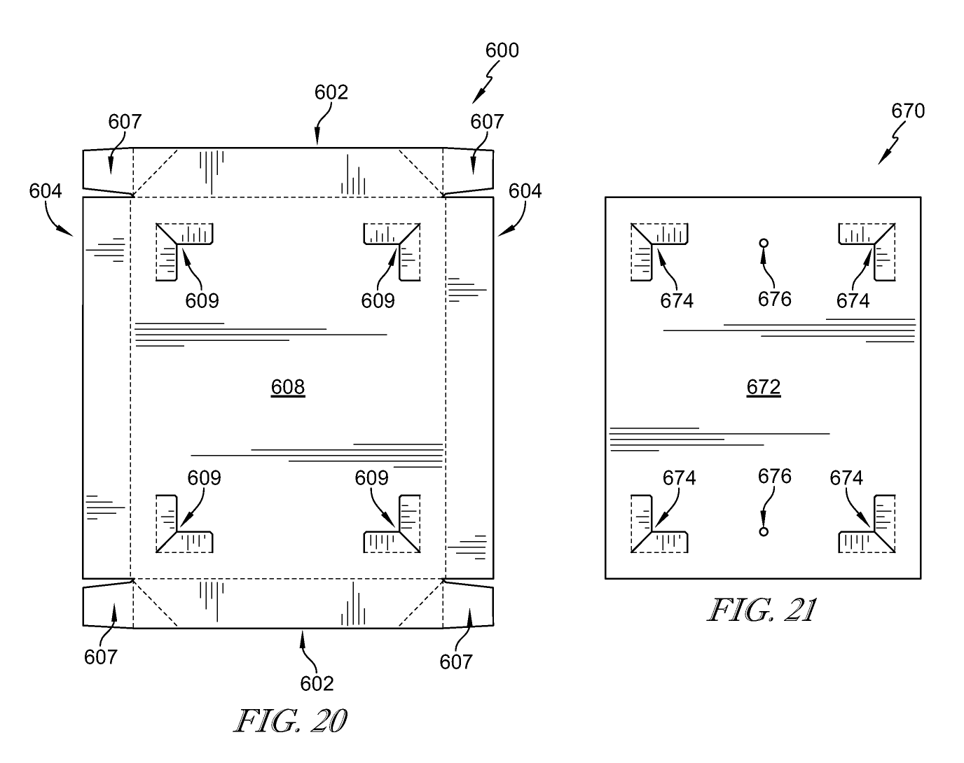

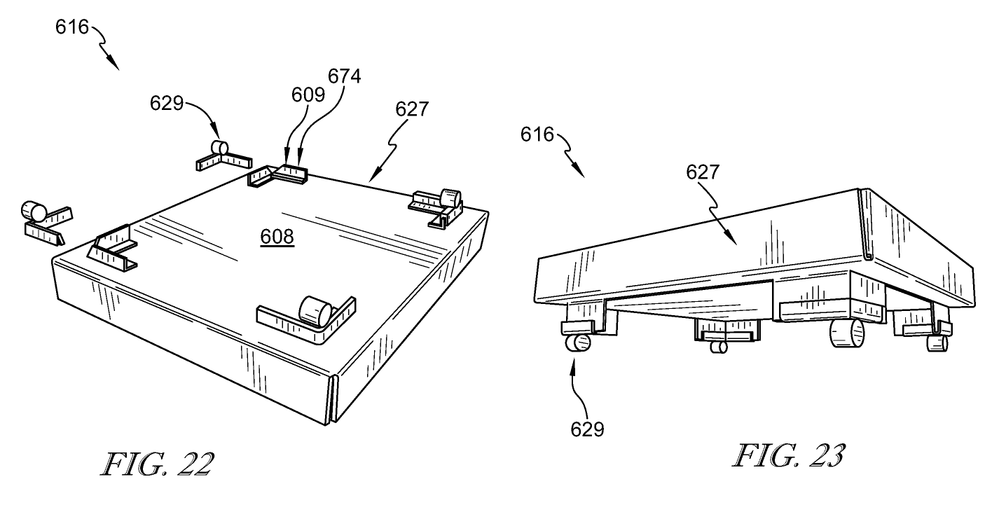

Another embodiment of a blank 600 is shown in FIG. 20 used to form part of a tray 627 of a display base 616 shown in FIGS. 22 and 23 in accordance with the present disclosure. Blank 600 includes end flaps 602 and side flaps 604 coupled to a bottom panel 608 as shown in FIG. 20. End flaps 602 and side flaps 604 fold relative to bottom panel 608, and coupler tabs 607 extending from end flaps 602 are bonded, with tape or adhesive for example, to side flaps 604 to hold end flaps 602 and side flaps 604 in a folded state.

A floor blank 670 includes a floor panel 672 and lock tabs 674 as shown in FIG. 21. Floor panel 672 is bonded with bottom panel 608 to form a tray of a display base. In some embodiments, floor panel 672 is formed to include holes 676. Bottom panel 608 of blank 600 is formed to include lock tabs 609, as suggested in FIG. 20, and lock tabs 674 of floor blank 670 cooperate with lock tabs 609 to hold rollers 629 on the formed tray 627, as suggested in FIG. 22.

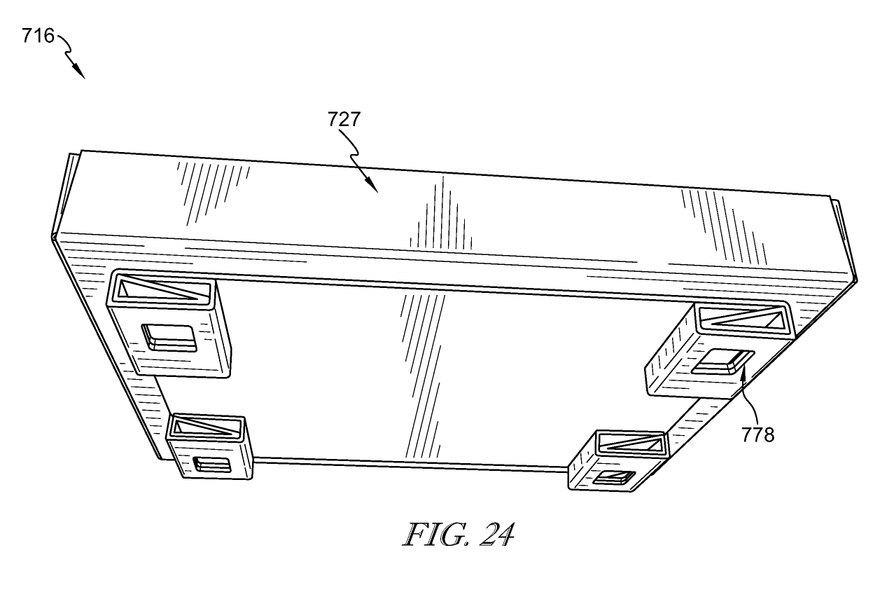

Another embodiment of a display base 716 in accordance with the present disclosure is shown in FIG. 24. Display base 716 includes a tray 727 and platforms 778 coupled to a bottom of tray 727 to support tray 727 above a ground level. In some embodiments, rollers attach with platforms 778.

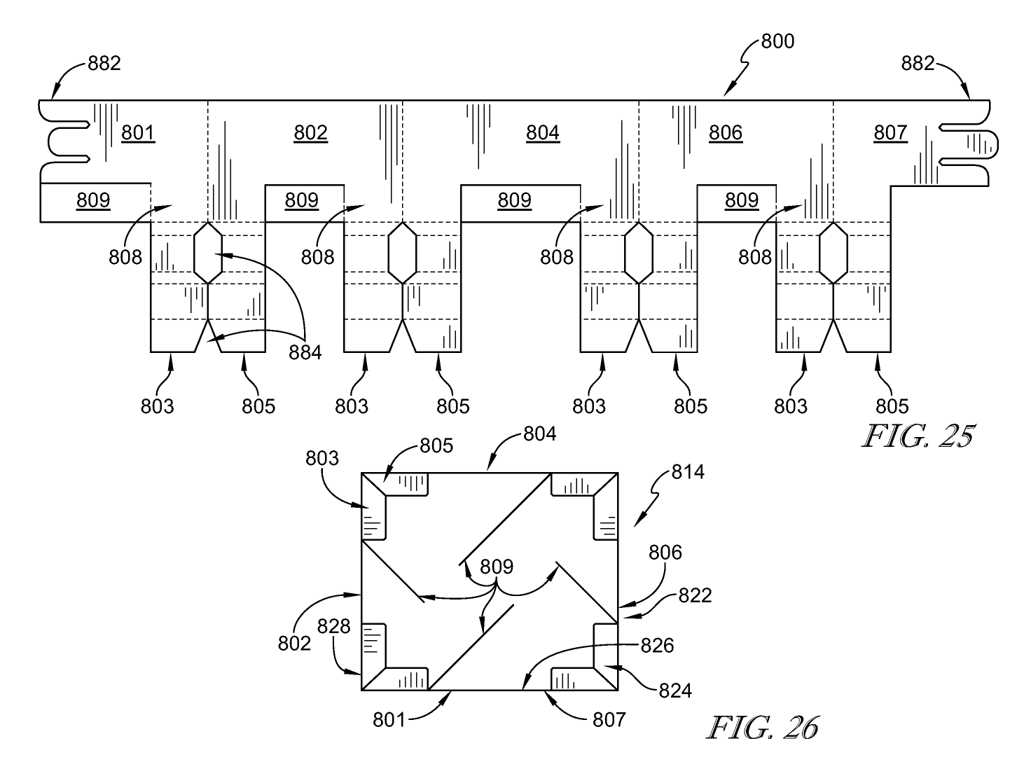

Another embodiment of a blank 800 is shown in FIG. 25 which is used to form a suspension base 814 shown in FIG. 26 in accordance with the present disclosure. Blank 800 is similar to blank 100, and includes side panels 802, 806, a back panel 804, and end panels 801, 807 as shown in FIG. 25. Grips 882 of end panels 801, 807 engage one another to form an interlock 826 as suggested in FIG. 26. Panels 801, 802, 804, 806, 807 form a perimeter wall 822 of suspension base 814.

In the illustrative embodiment, corner blocks 824 are formed from roll panels 803, 805 as suggested in FIGS. 25 and 26. Roll panels 803, 805 each include a plurality of sections which fold onto one another to align with lower sections 808 of the upper panels 801, 802, 804, 806, 807 to form feet 828 of suspension base 814. The sections of roll panels 803, 805 are sized such that roll panels meet with one another at respective corners of perimeter wall 822 when suspension base 814 is formed. For example, in the illustrative embodiment, gaps 884 are formed between roll panels 803, 805 to allow panels 801, 802, 804, 806, 807 to fold relative to one another without interference between roll panels 803, 805. Other fold patterns for corner blocks 824 are possible, such as triangular or other polygonal shape. In some embodiments, tape or adhesive is used to hold roll panels 803, 805 in a folded state.

In the illustrative embodiment, swing arms 809 are coupled to panels 801, 802, 804, 806 as shown in FIG. 25. Swing arms 809 fold relative to panels 801, 802, 804, 806 to extend toward one another as suggested in FIG. 26. An upper edge of swing arms 809 substantially aligns with an upper portion of corner blocks 824 to provide a floor used to support a display base in suspension base 814.

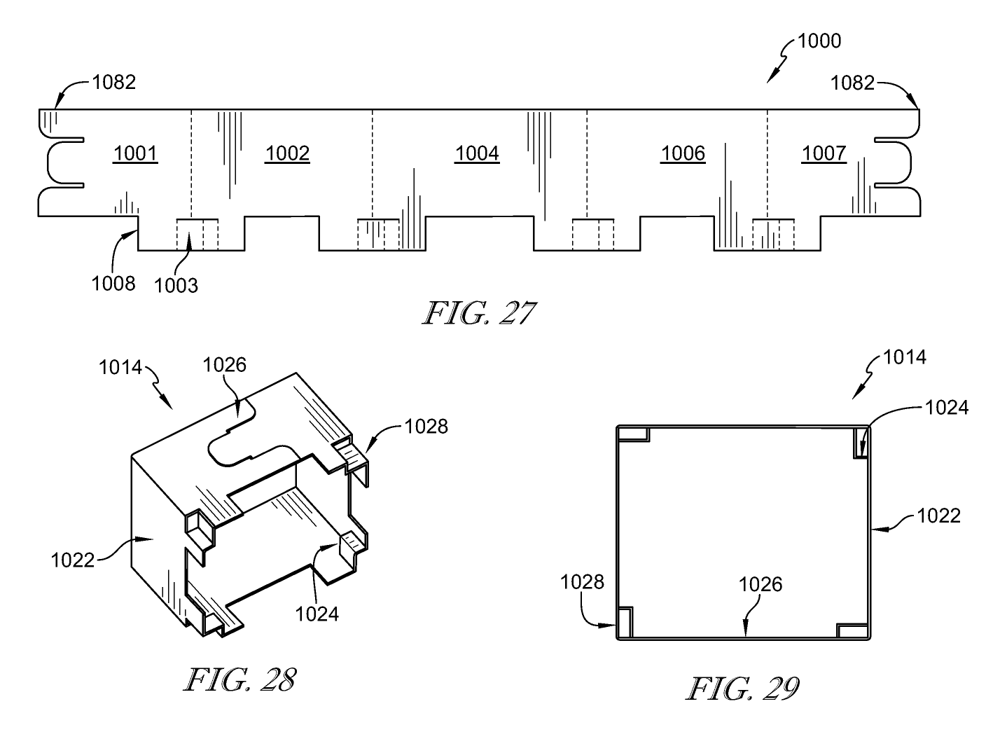

Another embodiment of a blank 1000 is shown in FIG. 27 which is used to form a suspension base 1014 shown in FIGS. 28 and 29 in accordance with the present disclosure. Blank 1000 includes side panels 1002, 1006, a back panel 1004, and end panels 1001, 1007 as shown in FIG. 27. Grips 1082 of end panels 1001, 1007 engage one another to form an interlock 1026 as suggested in FIG. 28. Panels 1001, 1002, 1004, 1006, 1007 form a perimeter wall 1022 of suspension base 1014.

In the illustrative embodiment, corner blocks 1024 are formed from bi-fold panels 1003 as suggested in FIGS. 27 and 28. Bi-fold panels 1003 each include a plurality of sections which fold relative to one another to extend inward from lower sections 1008 of the upper panels 1001, 1002, 1004, 1006, 1007 to form feet 1028 of suspension base 1014. While two sections are shown for each bi-fold panel 1003, more or less sections can be used.

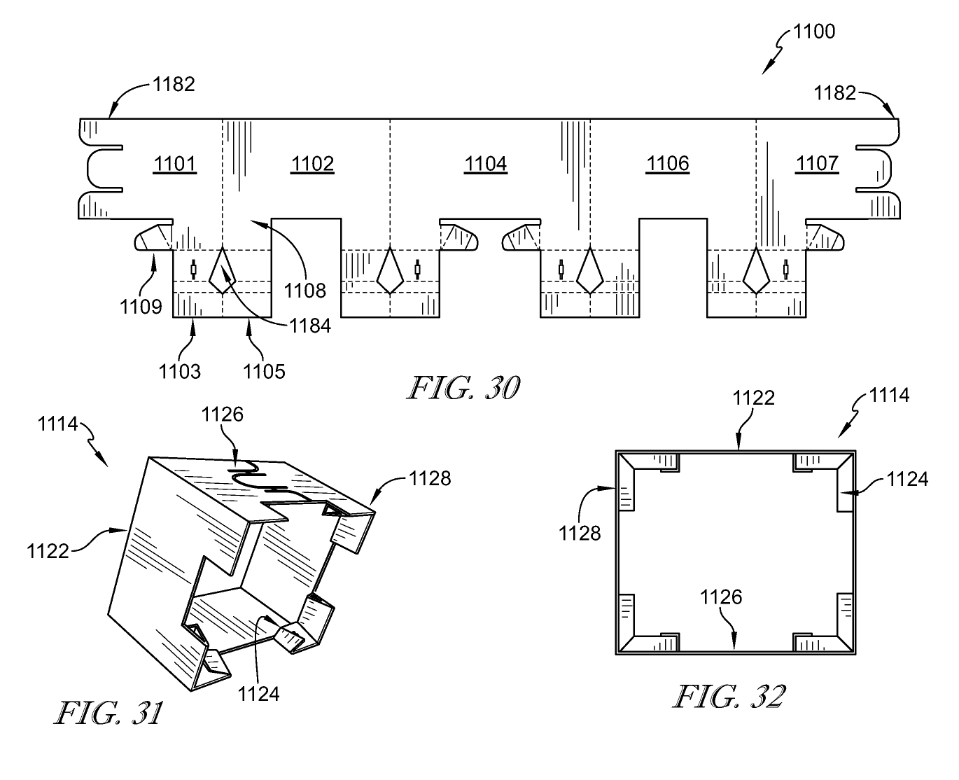

Another embodiment of a blank 1100 is shown in FIG. 30 which is used to form a suspension base 1114 shown in FIGS. 31 and 32 in accordance with the present disclosure. Blank 1100 is similar to blank 100, and includes side panels 1102, 1106, a back panel 1104, and end panels 1101, 1107 as shown in FIG. 30. Grips 1182 of end panels 1101, 1107 engage one another to form an interlock 1126 as suggested in FIG. 31. Panels 1101, 1102, 1104, 1106, 1107 form a perimeter wall 1122 of suspension base 1114.

In the illustrative embodiment, corner blocks 1124 are formed from roll panels 1103, 1105 and lock panels 1109 as suggested in FIGS. 30 and 31. Roll panels 1103, 1105 each include a plurality of sections which fold onto one another to align with lower sections 1108 of the upper panels 1101, 1102, 1104, 1106, 1107 to form feet 1128 of suspension base 1114. The sections of roll panels 1103, 1105 are sized such that roll panels meet with one another at respective corners of perimeter wall 1122 when suspension base 1114 is formed. For example, in the illustrative embodiment, gaps 1184 are formed between roll panels 1103, 1105 to allow panels 1101, 1102, 1104, 1106, 1107 to fold relative to one another without interference between roll panels 1103, 1105.

Lock panels 1109 engage with roll panels 1103 to hold roll panels 1103 in a folded state as suggested in FIG. 31. In some embodiments, another lock panel is included in blank 1100 to hold roll panels 1105 in a folded state. In some embodiments, tape or adhesive is used to hold roll panels 1103, 1105 in a folded state. Other fold patterns for corner blocks 1124 are possible, such as square or other polygonal shape.

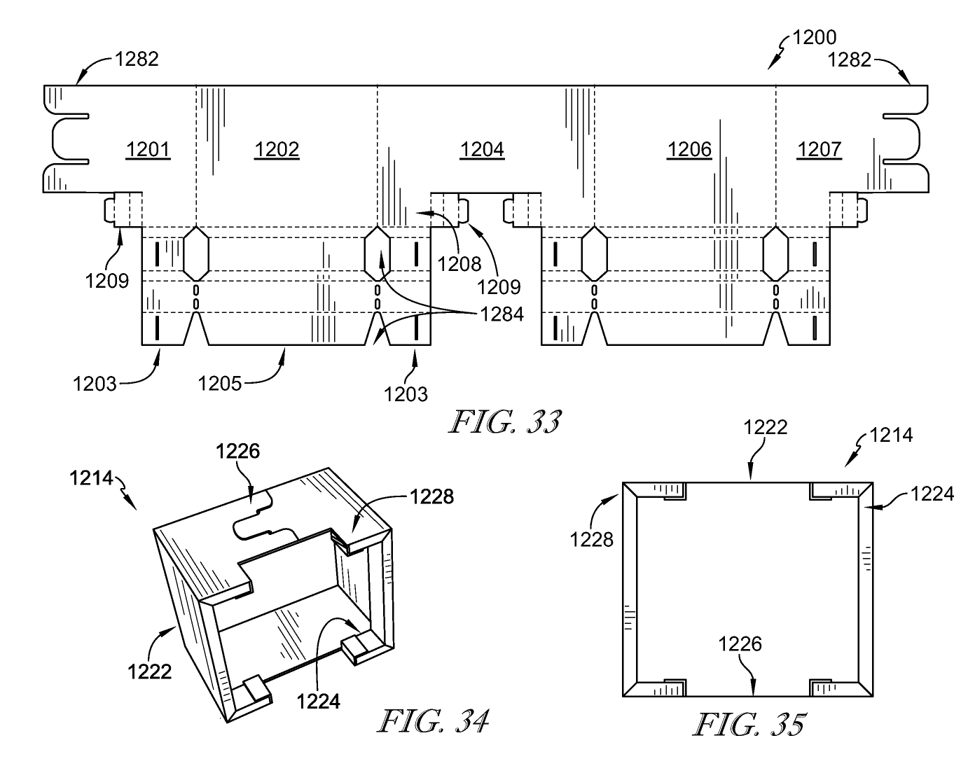

Another embodiment of a blank 1200 is shown in FIG. 33 which is used to form a suspension base 1214 shown in FIGS. 34 and 35 in accordance with the present disclosure. Blank 1200 is similar to blank 100, and includes side panels 1202, 1206, a back panel 1204, and end panels 1201, 1207 as shown in FIG. 33. Grips 1282 of end panels 1201, 1207 engage one another to form an interlock 1226 as suggested in FIG. 34. Panels 1201, 1202, 1204, 1206, 1207 form a perimeter wall 1222 of suspension base 1214.

In the illustrative embodiment, edge blocks 1224 extending along panels 1202, 1206 and the corners of suspension base 1214 are formed from roll panels 1203, 1205 and lock panels 1209 as suggested in FIGS. 33 and 34. Roll panels 1203, 1205 each include a plurality of sections which fold onto one another to align with lower sections 1208 of the upper panels 1201, 1202, 1204, 1206, 1207 to form feet 1228 of suspension base 1214. The sections of roll panels 1203, 1205 are sized such that roll panels meet with one another at respective corners of perimeter wall 1222 when suspension base 1214 is formed. For example, in the illustrative embodiment, gaps 1284 are formed between roll panels 1203, 1205 to allow panels 1201, 1202, 1204, 1206, 1207 to fold relative to one another without interference between roll panels 1203, 1205.

Lock panels 1209 engage with roll panels 1203 to hold roll panels 1203 in a folded state as suggested in FIG. 34. In some embodiments, only one lock panel 1209 is included in blank 1200. In some embodiments, tape or adhesive is used to hold roll panels 1203, 1205 in a folded state. Other fold patterns for edge blocks 1224 are possible, such as triangular or other polygonal shape.

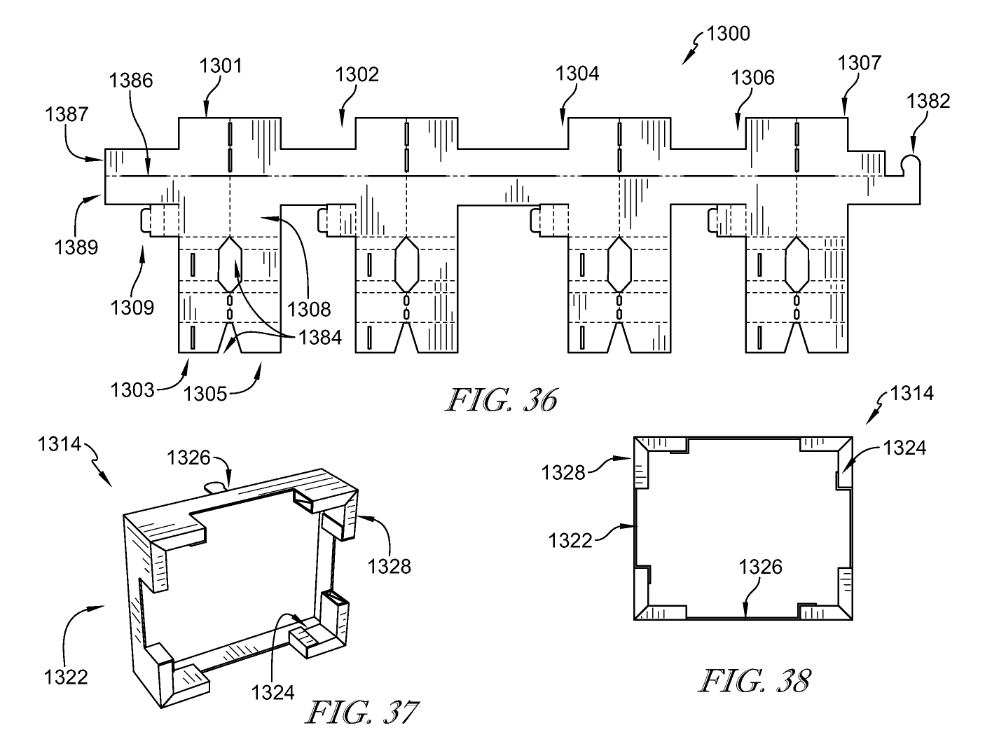

Another embodiment of a blank 1300 is shown in FIG. 36 which is used to form a suspension base 1314 shown in FIGS. 37 and 38 in accordance with the present disclosure. Blank 1300 is similar to blank 100, and includes side panels 1302, 1306, a back panel 1304, and end panels 1301, 1307 as shown in FIG. 36. Each panel 1301, 1302, 1304, 1306, 1307 includes an upper-half portion 1387 and a lower-half portion 1389. Upper-half portions 1387 fold relative to lower-half portions 1389 into confronting relation to define a reinforced, double-thickness perimeter wall 1322 of suspension base 1314 when panels 1301, 1302, 1304, 1306, 1307 are folded relative to one another. A hook 1382 of end panel 1307 engages with a slot 1386 of panel 1301 to form an interlock 1326 as suggested in FIG. 37.

In the illustrative embodiment, corner blocks 1324 are formed from roll panels 1303, 1305 and lock panels 1309 as suggested in FIGS. 36 and 37. Roll panels 1303, 1305 each include a plurality of sections which fold onto one another to align with lower sections 1308 of the upper panels 1301, 1302, 1304, 1306, 1307 to form feet 1328 of suspension base 1314. The sections of roll panels 1303, 1305 are sized such that roll panels meet with one another at respective corners of perimeter wall 1322 when suspension base 1314 is formed. For example, in the illustrative embodiment, gaps 1384 are formed between roll panels 1303, 1305 to allow panels 1301, 1302, 1304, 1306, 1307 to fold relative to one another without interference between roll panels 1303, 1305.

Lock panels 1309 engage with roll panels 1303 to hold roll panels 1303 in a folded state as suggested in FIG. 37. In some embodiments, another lock panel is included in blank 1300 to hold roll panels 1305 in a folded state. In some embodiments, tape or adhesive is used to hold roll panels 1303, 1305 in a folded state. Other fold patterns for corner blocks 1324 are possible, such as triangular or other polygonal shape.

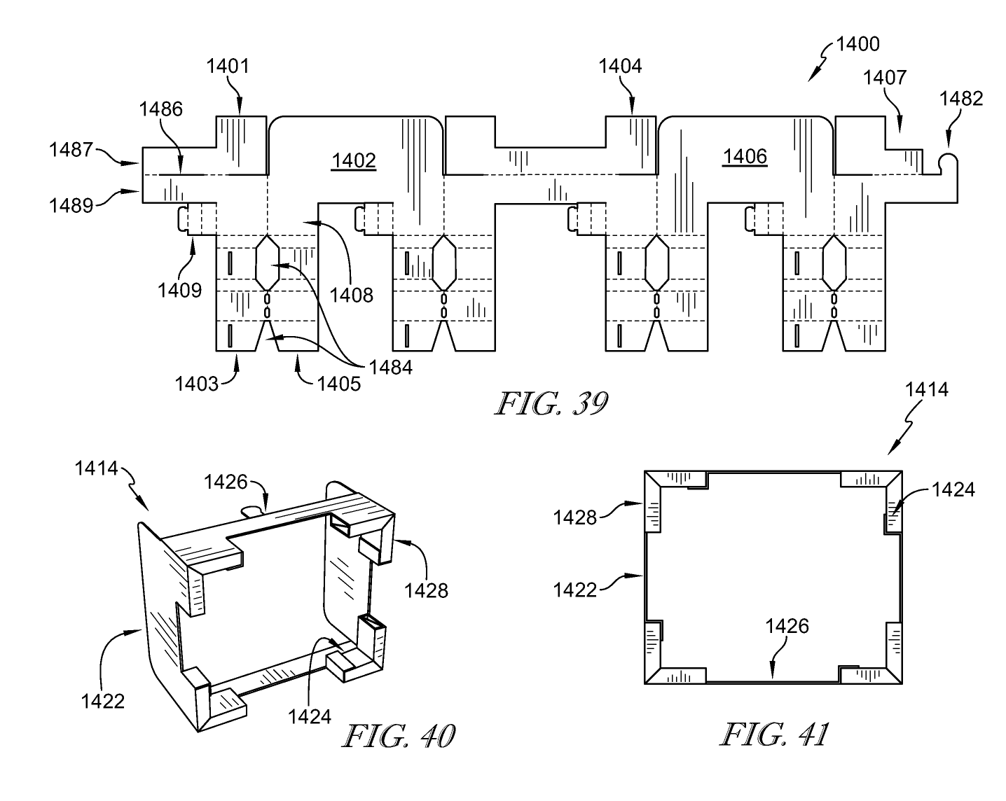

Another embodiment of a blank 1400 is shown in FIG. 39 which is used to form a suspension base 1414 shown in FIGS. 40 and 41 in accordance with the present disclosure. Blank 1400 is similar to blank 100, and includes side panels 1402, 1406, a back panel 1404, and end panels 1401, 1407 as shown in FIG. 39. Panels 1401, 1404, 1407 include an upper-half portion 1487 and a lower-half portion 1489. Upper-half portions 1487 fold relative to lower-half portions 1489 into confronting relation to define reinforced, double-thickness sections of a perimeter wall 1422 of suspension base 1414 when panels 1401, 1402, 1404, 1406, 1407 are folded relative to one another. A hook 1482 of end panel 1407 engages with a slot 1486 of panel 1401 to form an interlock 1426 as suggested in FIG. 40.

In the illustrative embodiment, corner blocks 1424 are formed from roll panels 1403, 1405 and lock panels 1409 as suggested in FIGS. 39 and 40. Roll panels 1403, 1405 each include a plurality of sections which fold onto one another to align with lower sections 1408 of the upper panels 1401, 1402, 1404, 1406, 1407 to form feet 1428 of suspension base 1414. The sections of roll panels 1403, 1405 are sized such that roll panels meet with one another at respective corners of perimeter wall 1422 when suspension base 1414 is formed. For example, in the illustrative embodiment, gaps 1484 are formed between roll panels 1403, 1405 to allow panels 1401, 1402, 1404, 1406, 1407 to fold relative to one another without interference between roll panels 1403, 1405.

Lock panels 1409 engage with roll panels 1403 to hold roll panels 1403 in a folded state as suggested in FIG. 40. In some embodiments, another lock panel is included in blank 1400 to hold roll panels 1405 in a folded state. In some embodiments, tape or adhesive is used to hold roll panels 1403, 1405 in a folded state. Other fold patterns for corner blocks 1424 are possible, such as triangular or other polygonal shape.

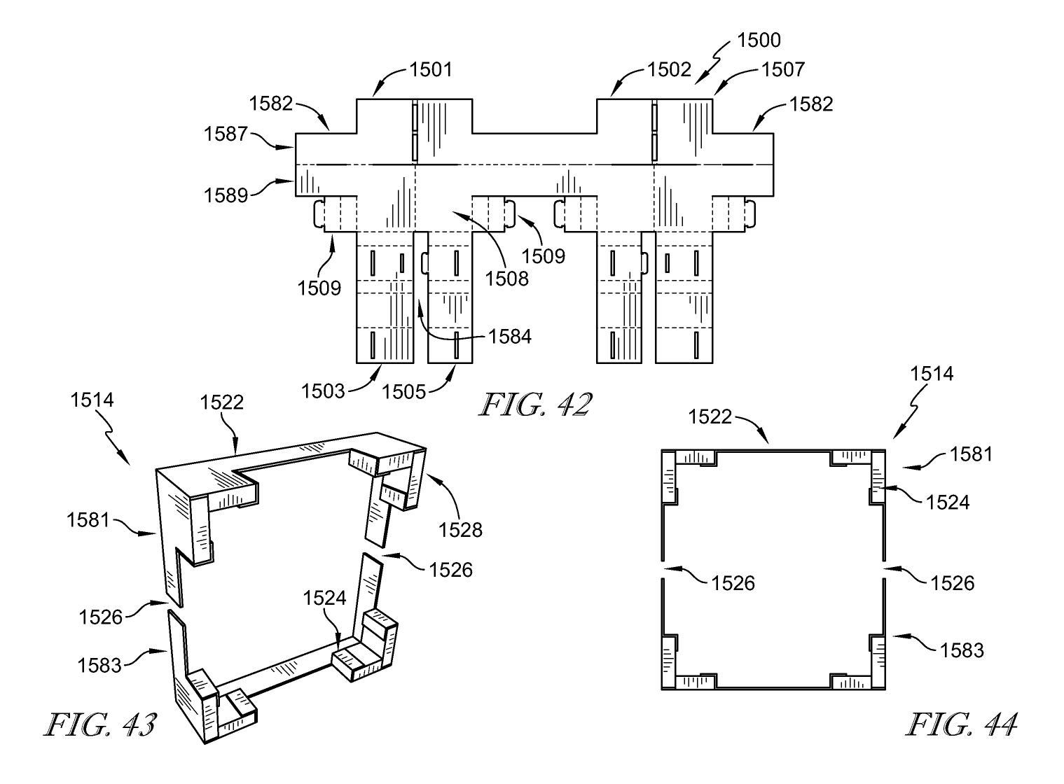

Another embodiment of a blank 1500 is shown in FIG. 42 which is used to form base halves 1581, 1583 for erecting a suspension base 1514 shown in FIGS. 43 and 44 in accordance with the present disclosure. Blank 1500 includes a side panel 1502 and end panels 1501, 1507 as shown in FIG. 42. Panels 1501, 1502, 1507 include an upper-half portion 1587 and a lower-half portion 1589. Upper-half portions 1587 fold relative to lower-half portions 1589 into confronting relation to define reinforced, double-thickness sections of a perimeter wall 1522 of suspension base 1514 when panels 1501, 1502, 1507 are folded relative to one another. Sections 1582 of end panels 1501, 1507 of base half 1581 align with sections 1582 of base half 1539 to define suspension base 1514 as suggested in FIG. 40. In some embodiments, sections 1582 of base halves 1581, 1583 engage with one another to form an interlock 1526 between base halves 1581, 1583. In some embodiments, tape or adhesive is used to attach sections 1582 together.

In the illustrative embodiment, corner blocks 1524 are formed from roll panels 1503, 1505 and lock panels 1509 as suggested in FIGS. 42 and 43. Roll panels 1503, 1505 each include a plurality of sections which fold onto one another to align with lower sections 1508 of the upper panels 1501, 1502, 1507 to form feet 1528 of suspension base 1514. The sections of roll panels 1503, 1505 are sized such that roll panels meet with one another at respective corners of perimeter wall 1522 when suspension base 1514 is formed. For example, in the illustrative embodiment, gaps 1584 are formed between roll panels 1503, 1505 to allow panels 1501, 1502, 1507 to fold relative to one another without interference between roll panels 1503, 1505.

Lock panels 1509 engage with roll panels 1503 to hold roll panels 1503 in a folded state as suggested in FIG. 43. In some embodiments, another lock panel is included in blank 1500 to hold roll panels 1505 in a folded state. In some embodiments, tape or adhesive is used to hold roll panels 1503, 1505 in a folded state. Other fold patterns for corner blocks 1524 are possible, such as triangular or other polygonal shape.

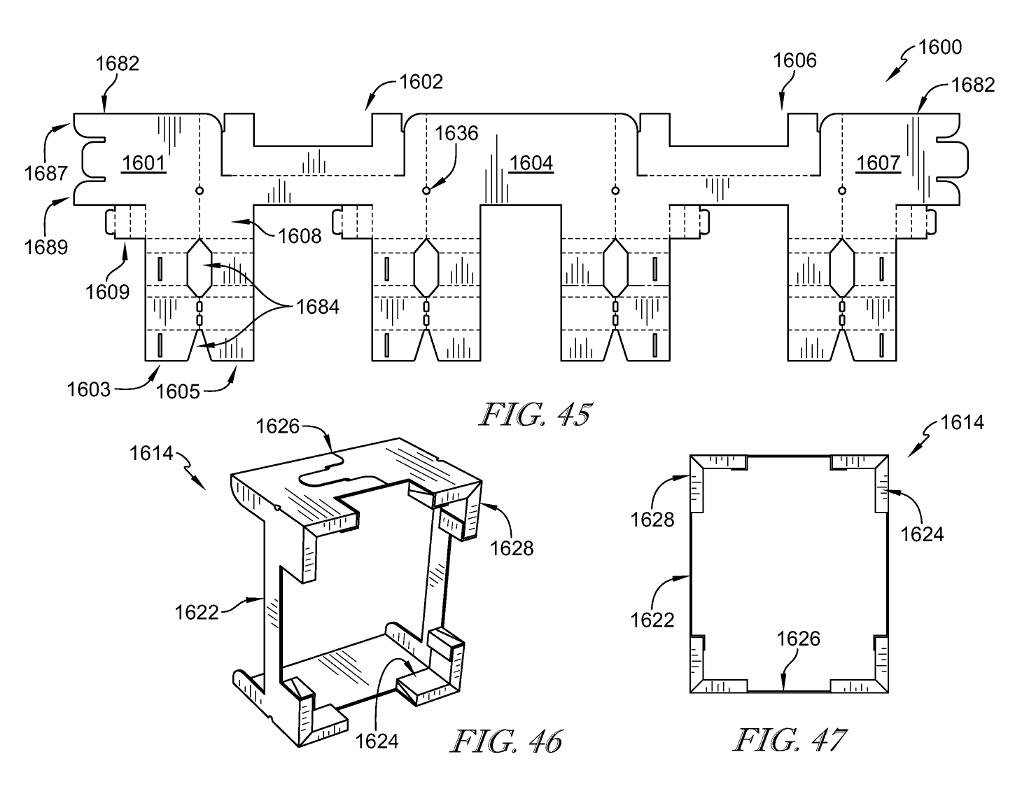

Another embodiment of a blank 1600 is shown in FIG. 45 which is used to form a suspension base 1614 shown in FIGS. 46 and 47 in accordance with the present disclosure. Blank 1600 is similar to blank 100, and includes side panels 1602, 1606, a back panel 1604, and end panels 1601, 1607 as shown in FIG. 45. Panels 1602, 1606 include an upper-half portion 1687 and a lower-half portion 1689. Upper-half portions 1687 fold relative to lower-half portions 1689 into confronting relation to define reinforced, double-thickness sections of a perimeter wall 1622 of suspension base 1614 when panels 1601, 1602, 1604, 1606, 1607 are folded relative to one another. A hook 1682 of end panel 1607 engages with a slot 1686 of panel 1601 to form an interlock 1626 as suggested in FIG. 46.

In the illustrative embodiment, corner blocks 1624 are formed from roll panels 1603, 1605 and lock panels 1609 as suggested in FIGS. 45 and 46. Roll panels 1603, 1605 each include a plurality of sections which fold onto one another to align with lower sections 1608 of the upper panels 1601, 1602, 1604, 1606, 1607 to form feet 1628 of suspension base 1614. The sections of roll panels 1603, 1605 are sized such that roll panels meet with one another at respective corners of perimeter wall 1622 when suspension base 1614 is formed. For example, in the illustrative embodiment, gaps 1684 are formed between roll panels 1603, 1605 to allow panels 1601, 1602, 1604, 1606, 1607 to fold relative to one another without interference between roll panels 1603, 1605.

Lock panels 1609 engage with roll panels 1603 to hold roll panels 1603 in a folded state as suggested in FIG. 46. In some embodiments, another lock panel is included in blank 1600 to hold roll panels 1605 in a folded state. In some embodiments, tape or adhesive is used to hold roll panels 1603, 1605 in a folded state. Other fold patterns for corner blocks 1624 are possible, such as triangular or other polygonal shape.

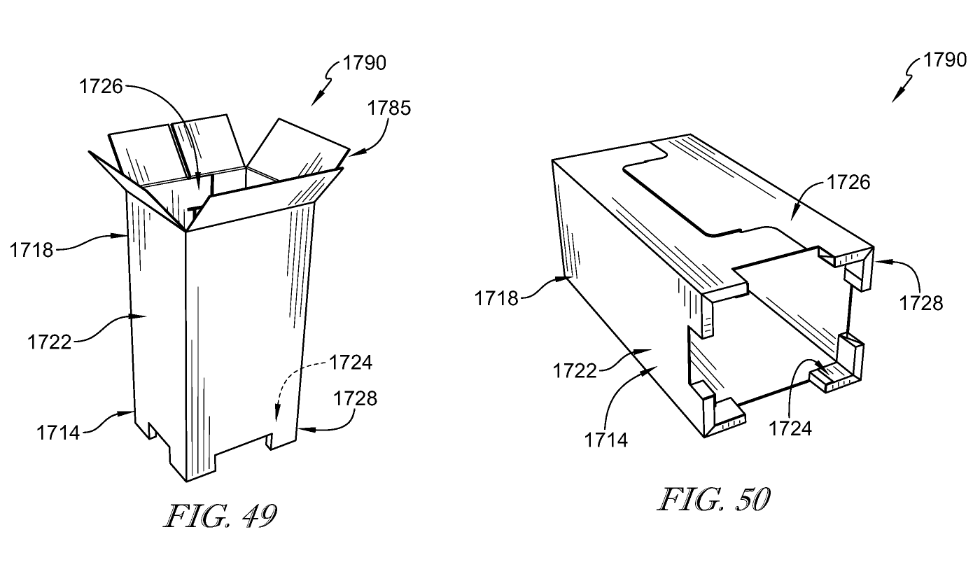

One embodiment of a blank 1700 is shown in FIG. 48 which is used to form a suspension cover 1790 shown in FIGS. 49 and 50 in accordance with the present disclosure. Suspension cover 1790 includes a suspension base portion 1714 and a cover member portion 1718. Suspension base portion 1714 is configured to receive and support a mobile display base and an attached display vehicle holding product. Cover member portion 1718 is configured to enclose the display base and attached display vehicle to form a transport package around the display vehicle for transport of the display vehicle to a retail location where the product is sold to consumers.

Blank 1700 includes side panels 1702, 1706, a back panel 1704, and end panels 1701, 1707 as shown in FIG. 48. Grips 1782 of end panels 1701, 1707 engage one another to form an interlock 1726 as suggested in FIG. 50. Panels 1701, 1702, 1704, 1706, 1707 form a perimeter wall 1722 of suspension cover 1790. Closure flaps 1785 fold relative to panels 1701, 1702, 1704, 1706, 1707 to close an upper opening of suspension cover 1790 as suggested in FIG. 49.

In the illustrative embodiment, corner blocks 1724 are formed from roll panels 1703, 1705 and lock panels 1709 as suggested in FIGS. 48 and 50. Roll panels 1703, 1705 each include a plurality of sections which fold onto one another to align with lower sections 1708 of the upper panels 1701, 1702, 1704, 1706, 1707 to form feet 1728 of suspension cover 1790. The sections of roll panels 1703, 1705 are sized such that roll panels meet with one another at respective corners of perimeter wall 1722 when suspension cover 1790 is formed. For example, in the illustrative embodiment, gaps 1784 are formed between roll panels 1703, 1705 to allow panels 1701, 1702, 1704, 1706, 1707 to fold relative to one another without interference between roll panels 1703, 1705.

Lock panels 1709 engage with roll panels 1703 to hold roll panels 1703 in a folded state as suggested in FIG. 50. In some embodiments, another lock panel is included in blank 1700 to hold roll panels 1705 in a folded state. In some embodiments, tape or adhesive is used to hold roll panels 1703, 1705 in a folded state. Other fold patterns for corner blocks 1724 are possible, such as triangular or other polygonal shape.

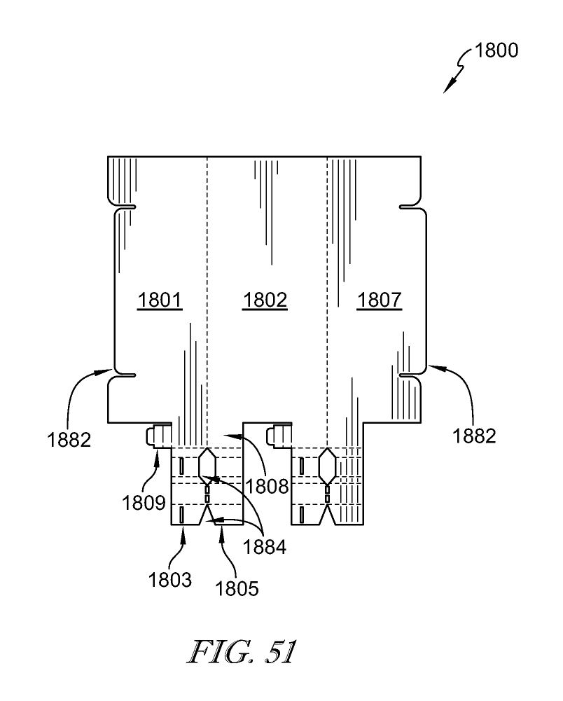

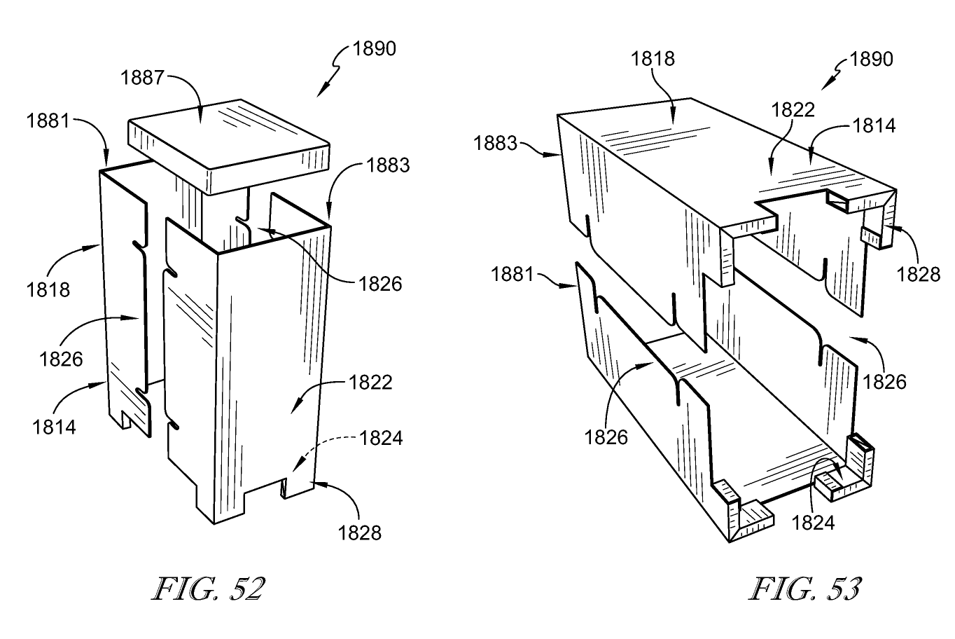

Another embodiment of a blank 1800 is shown in FIG. 51 which is used to form suspension-cover halves 1881, 1883 used to erect a suspension cover 1890 shown in FIGS. 52 and 53 in accordance with the present disclosure. Suspension cover 1890 includes a suspension base portion 1814 and a cover member portion 1818. A closure member 1887 attaches to suspension cover 1890 to close an upper opening of suspension cover. Suspension base portion 1814 is configured to receive and support a mobile display base and an attached display vehicle holding product. Cover member portion 1818 is configured to enclose the display base and attached display vehicle to form a transport package around the display vehicle for transport of the display vehicle to a retail location where the product is sold to consumers.

Blank 1800 includes side panels 1802, 1806, a back panel 1804, and end panels 1801, 1807 as shown in FIG. 51. Grips 1882 of end panels 1801, 1807 for each base half 1881, 1883 engage with one another to form interlocks 1826 between base halves 1881, 1883 as suggested in FIGS. 52 and 53. Panels 1801, 1802, 1804, 1806, 1807 form a perimeter wall 1822 of suspension cover 1890.

In the illustrative embodiment, corner blocks 1824 are formed from roll panels 1803, 1805 and lock panels 1809 as suggested in FIGS. 51 and 53. Roll panels 1803, 1805 each include a plurality of sections which fold onto one another to align with lower sections 1808 of the upper panels 1801, 1802, 1804, 1806, 1807 to form feet 1828 of suspension cover 1890. The sections of roll panels 1803, 1805 are sized such that roll panels meet with one another at respective corners of perimeter wall 1822 when suspension cover 1890 is formed. For example, in the illustrative embodiment, gaps 1884 are formed between roll panels 1803, 1805 to allow panels 1801, 1802, 1804, 1806, 1807 to fold relative to one another without interference between roll panels 1803, 1805.

Lock panels 1809 engage with roll panels 1803 to hold roll panels 1803 in a folded state as suggested in FIG. 53. In some embodiments, another lock panel is included in blank 1800 to hold roll panels 1805 in a folded state. In some embodiments, tape or adhesive is used to hold roll panels 1803, 1805 in a folded state. Other fold patterns for corner blocks 1824 are possible, such as triangular or other polygonal shape.

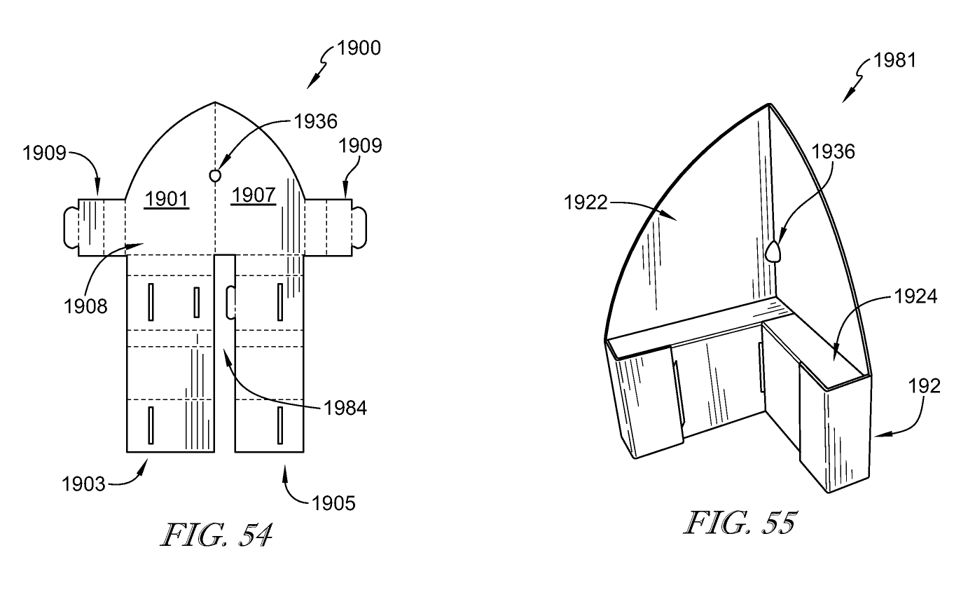

One embodiment of a blank 1900 is shown in FIG. 54 which is used to form suspension corners 1981 shown in FIG. 55 that can be arranged to define a suspension base in accordance with the present disclosure. For example, four suspension corners 1981 can be arranged at four corners of a display base to define a suspension base for supporting the display base. In some embodiments, a strap is positioned around perimeter walls 1922 and in notches 1936 of suspension corners 1981 to hold suspension corners 1981 on the display base. In some embodiments, a high shear, low tensile adhesive is applied along a top surface of a corner block 1924 of suspension corner 1981 to hold suspension corner 1981 on the display base.

Blank 1900 includes end panels 1901, 1907 as shown in FIG. 54. In the illustrative embodiment, corner blocks 1924 are formed from roll panels 1903, 1905 and lock panels 1909 as suggested in FIGS. 54 and 55. Roll panels 1903, 1905 each include a plurality of sections which fold onto one another to align with lower sections 1908 of the upper panels 1901, 1907 to form a foot 1928 of suspension corner 1981. The sections of roll panels 1903, 1905 are sized such that roll panels meet with one another at respective corners of perimeter wall 1922 when suspension corner 1981 is formed. For example, in the illustrative embodiment, gaps 1984 are formed between roll panels 1903, 1905 to allow panels 1901, 1907 to fold relative to one another without interference between roll panels 1903, 1905.

Lock panels 1909 engage with roll panels 1903, 1905 to hold roll panels 1903, 1905 in a folded state as suggested in FIG. 55. In some embodiments, only one lock panel 1909 is included in blank 1900. In some embodiments, tape or adhesive is used to hold roll panels 1903, 1905 in a folded state. Other fold patterns for corner blocks 1924 are possible, such as triangular or other polygonal shape.

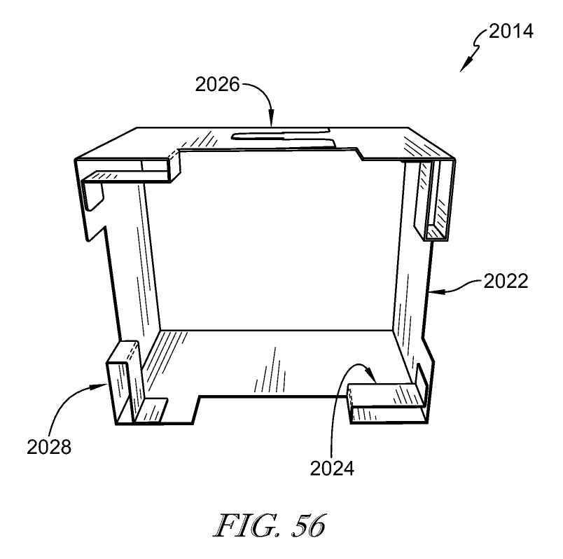

Another embodiment of a suspension base 2014 in accordance with the present disclosure is shown in FIG. 56. Suspension base 14 is formed from a blank of material which is cut and folded into shape. Suspension base 2014 includes a perimeter wall 2022 and corner blocks 2024 coupled to perimeter wall 2022. An interlock 2026 of perimeter wall 2022 is configured to hold suspension base 2014 in an folded state. Suspension base 2014 is formed to include feet 2028 such that one or more windows are defined between adjacent feet 2028. In the illustrative embodiment, material extending between adjacent feet 2028 is folded and attached to an inside surface of feet 2028 for form corner blocks 2024. In some embodiments, corner blocks 2024 are attached by tape or adhesive, for example.

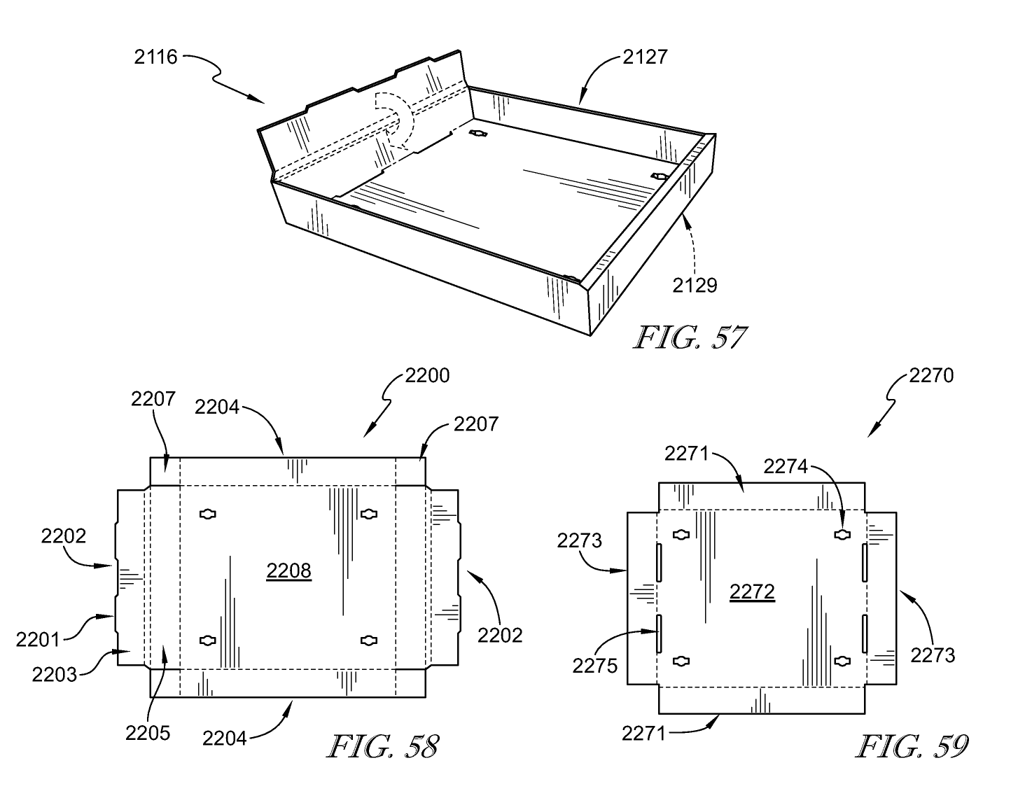

Another embodiment of a display base 2116 in accordance with the present disclosure is shown in FIG. 57. Display base 2116 includes a tray 2127 and rollers 2129 coupled to tray 2127. In the illustrative embodiment, display base 2116 is formed from cooperating blanks 2200, 2270 of material, as shown in FIGS. 58 and 59, which are cut, assembled, and folded into shape as described further below.

Blank 2200 includes end flaps 2202 and side flaps 2204 coupled to a bottom panel 2208 as shown in FIG. 58. Bottom panel 2208 is formed to include keyholes 2203. End flaps 2202 each include wall panels 2203, 2205. Retention tabs 2207 extend from side flaps 2204. A floor blank 2270 includes edge flaps 2271, 2273 attached to a floor panel 2272 as shown in FIG. 59. Floor panel 2272 is formed to include keyholes 2274.

In one embodiment of assembling blanks 2200, 2270 together into tray 2127, blanks 2200, 2270 are aligned with one another, such as by aligning keyholes 2203, 2274. Edge flaps 2271, 2273 of floor blank 2270 are folded relative to floor panel 2272. Retention tabs 2207 of blank 2200 are folded relative to side flaps 2204, and side flaps 2204 are folded relative to bottom panel 2208 such that retention tabs 2207 extend along floor panel 2272 and in confronting relation to edge flaps 2273. Wall panels 2205 are folded relative to bottom panel 2208, and wall panels 2203 are folded relative to wall panels 2205 over and into confronting relation with edge flaps 2273, such that edge flaps 2273 and retention tabs 2207 are received between wall panels 2203, 2205 to hold side flap 2204 in a folded state. Lock tabs 2201 on wall panel 2203 engage with slots 2275 in floor panel 2272 to hold end flap 2202 in a folded state. In some embodiments, floor panel 2272 is bonded with bottom panel 2208. In some embodiments, rollers 2129 engage with keyholes 2203, 2272 to lock rollers 2129 onto tray 2127. In some embodiments, tape or adhesive is used to hold tray 2127 in a folded state.

It is within the scope of the present disclosure to make blanks in accordance with the present disclosure from a variety of materials including corrugated paperboard, folding carton, solid fiber, plastic sheeting, plastic corrugated, combinations thereof, or any other suitable material.

In illustrative embodiments, the suspension base is formed from a flat sheet with five sidewall panels that can be formed into a tube. In one embodiment, the blank (or sheet) includes a continuous length panel with two adjacent width panels with two more adjacent panels which, when combined, form another length panel. There is an interlocking feature in the last two panels which allow the sheet to lock together forming a square or rectangular tube. Using the suspension base of the present disclosure can eliminate the cost and complicity of a pallet and cradle typically used for transporting a display base with casters.

In illustrative embodiments, the sheet also has multiple panels attached to the bottom edge in areas adjacent to the corners. These panels can be folded and locked to create supporting blocks on the inside corners of the tube. The main sidewall panels have cut out sections at the bottom to provide access for material handling equipment such as a fork truck or pallet jack. In some embodiments, the suspension base includes top flaps to provide a full enclosure for the contents.

In illustrative embodiments, a mobile display base consists of a tray with a reinforced side and bottom that has cut outs to accommodate casters or glides near the corners. A WIP cart is placed on a track of an assembly line with side guides. The suspension base, mobile misplay base, and display vehicles loaded with product are assembled onto the WIP cart as it is moved down the track past the various stations. At the end of packing, a dust cover is placed over the display vehicle and secured inside the suspension base with a horizontal band. In some embodiments, the display vehicle is quarter-pallet sized, and four units are gathered together and unitized with a stretch wrap or strap. The quad unit is then lifted off the WIP carts with a fork truck and staged for banding and shipping. The WIP carts are then reused.

In illustrative embodiments, the suspension base is folded, joined, and placed on the WIP cart. In some embodiments, locating pins on the WIP cart can be used to ensure the suspension base stays in place during packing. The mobile display base tray is assembled and casters installed. The display base is then placed inside the suspension base where it rests upon the suspension blocks. The suspension base effectively supports the tray and any display it may contain while providing clearance for the casters or glides during shipping and handling without the use of a pallet.

In illustrative embodiments, the display base includes of a tray like structure that encloses the lower portion of a display vehicle. The tray is supported by casters which permit the mobile display base and supported display vehicle(s) to be moved within a retail location. The casters are affixed by clipping onto the tray or through a hole configured to secure the caster.

In illustrative embodiments, the suspension base and display base are disposable or recyclable. The suspension base and the display base can be returned to the packer for reuse. The suspension base and display base allow easy deployment at a retail center.

1. A transport package comprising
a suspension base having a perimeter wall and an interior support structure coupled to the perimeter wall, the suspension base being formed to define feet configured to support the suspension base, the feet being separated by windows, and the perimeter wall being formed to include a notch,
a display base including a tray and a plurality of rollers coupled to the tray and configured to support the tray for rolling movement, the display base being dimensioned to fit within the suspension base and supported by the interior support structure to cause the rollers to be elevated relative to a lower end of the feet of the suspension base,
a display vehicle positioned on the tray of the display base, the display vehicle being adapted to support product therein,
a cover member configured to cover the display vehicle and having a portion that engages with the suspension base, the cover member being formed to include a notch, and
a securement strap arranged to extend around the suspension base and the cover member,
wherein the notches of the suspension base and the cover member align when the portion of the cover member is engaged with the suspension base and the securement strap is arranged to extend through the notches of the cover member and the suspension base to block removal of the cover member from the suspension base at the selection of a user.

2. The transport package of claim 1, wherein the perimeter wall includes four sides intersecting at four corners.

3. The transport package of claim 2, wherein the support structure includes four corner blocks positioned at the four corners of the perimeter wall.

4. The transport package of claim 3, wherein each corner block is formed by two roll panels having a plurality of sections folded onto one another, and wherein each roll panel is coupled to a different side of the perimeter wall from the other roll panel defining the corner block.

5. The transport package of claim 2, wherein one side of the perimeter wall is defined by two grips that engage with one another to form an interlock for holding the grips together.

6. The transport package of claim 1, wherein the suspension base is formed from a single unitary blank of material.

7. A transport package comprising
a suspension base having a perimeter wall and an interior support structure coupled to the perimeter wall, the suspension base being formed to include feet configured to support the suspension base, the feet being separated by windows,
a display base including a tray and a plurality of rollers coupled to the tray to support the tray for rolling movement, the display base being dimensioned to fit within the suspension base and supported by the interior support structure to cause the rollers to be elevated relative to a lower end of the feet of the suspension base,
a display vehicle positioned on the tray of the display base, the display vehicle being adapted to support product therein, and
a cover member configured to surround the display vehicle and having a portion that engages with the suspension base to block removal of the display vehicle and display base from the suspension base at the selection of a user.

8. The transport package of claim 7, wherein the suspension base and cover member are unitary.

9. The transport package of claim 7, wherein the perimeter wall includes four sides intersecting at four corners.

10. The transport package of claim 9, wherein the support structure includes four corner blocks positioned at the four corners of the perimeter wall.

11. The transport package of claim 10, wherein each corner block is defined by two roll panels having a plurality of sections folded onto one another, and wherein each roll panel is coupled to a different side of the perimeter wall from the other roll panel defining the corner block.

12. The transport package of claim 9, wherein one side of the perimeter wall is defined by two grips that engage with one another to form an interlock for holding the grips together.

13. The transport package of claim 7, wherein the suspension base is formed from a single blank of material.

14. A support base comprising
a suspension base having a perimeter wall and an interior support structure coupled to the perimeter wall, the suspension base including feet configured to support the suspension base, the feet being separated by windows, and
a display base having a tray and a plurality of rollers coupled to the tray to support the tray for rolling movement, the display base being dimensioned to fit within the suspension base and supported by the interior support structure such that the rollers are elevated relative to a lower end of the feet of the suspension base.

15. The transport package of claim 14, wherein the perimeter wall includes four sides intersecting at four corners.

16. The transport package of claim 15, wherein the support structure includes four corner blocks positioned at the four corners of the perimeter wall.

17. The transport package of claim 16, wherein each corner block is formed by two roll panels having a plurality of sections folded onto one another, and wherein each roll panel is coupled to a different side of the perimeter wall from the other roll panel forming the corner block.

18. The transport package of claim 16, further comprising a plurality of lock panels coupled to the perimeter wall, wherein each lock panel engages with one of the roll panels to retain the roll panels in a folded state.

19. The transport package of claim 15, wherein one side of the perimeter wall is defined by two grips that engage with one another to form an interlock for holding the grips together.

20. The transport package of claim 14, wherein the suspension base is formed from a single unitary blank of material.
